(19) United States
(12) Patent Application Publication
(10) Pub. No.: US 2025/0136455 A1
(43) Pub. Date: May 1, 2025

(54) SYSTEMS AND PROCESSES FOR THE PREPARATION OF PRECIPITATED SILICA

(71) Applicant: YEDA RESEARCH AND DEVELOPMENT CO. LTD., Rehovot (IL)

(72) Inventors: Assaf GAL, Taoz (IL); Hang ZHAI, Rehovot (IL)

(73) Assignee: YEDA RESEARCH AND DEVELOPMENT CO. LTD., Rehovot (IL)

(21) Appl. No.: 18/834,653

(22) PCT Filed: Feb. 16, 2023
(86) PCT No.: PCT/IL2023/050165

§ 371 Date: Aug. 1, 2024

Related U.S. Application Data
(60) Provisional application No. 63/399,870, filed on Aug. 22, 2022.
(60) Provisional application No. 63/340,964, filed on May 12, 2022.
(60) Provisional application No. 63/310,599, filed on Feb. 16, 2022.

(51) Int. Cl. C01B 33/193

(52) U.S. Cl. CPC C01B 33/193; C01P 2002/85; C01P 2002/88; C01P 2004/03; C01P 2004/04

(57) ABSTRACT

The invention relates to processes and systems for use in the control of morphology of precipitated silica.

### BACKGROUND OF THE INVENTION

Nanostructured silica is a widely used material, with applications in food industries, paints, catalysis, and biomedical materials. This is due to its high chemical stability, negligible cytotoxicity, and good biocompatibility. To meet the production requirements, a large number of synthetic techniques have been developed in recent decades. For instance, fumed silica is widely used in industry, but the harsh reaction conditions and high energy requirements restrict its applications in the current energy and environmentally conscious society. The classical aqueous approaches, e.g. the stöber sol-gel method, use toxic alkoxysilanes (Si(OR)₄) as silica precursors and require organic solvents under highly basic conditions. In addition, the available synthetic techniques have only limited control over the morphologies and/or composition of the silica products, which further limits their practical applications.

In contrast, organisms synthesize silica under mild conditions, which provides inspiration for new routes for silica production. Among the bio-silicifying organisms, diatoms attract the most attention due to their sophisticated silica cell-walls with 3D geometrical patterns. Studies on diatom biosilica led to the discovery of silaffins (proteins with high silica affinity) which can trigger the precipitation of silica in vitro and control their morphologies. In the silaffin sequences, the hydroxyl amino acids and serine residues are phosphorylated, and the lysine residues are modified with long-chain polyamine (LCPAs) moieties.

The silica-precipitating activity of silaffins crucially depends on these post-translational modifications as dephosphorylated silaffins are unable to induce silica precipitation in vitro. In addition, silaffins without LCPA, such as the native silaffin-2 (a negatively charged phosphoprotein), completely lose their silica-precipitating activity. Only addition of the polycations (e. g. native silaffin-1A or LCPAs) induces silica precipitation. These findings highlight the importance of both polycationic (LCPAs) and polyanionic (phosphoproteins) moieties in diatom bio-silicification processes.

Inspired by the various macromolecules found in diatom silica, many synthetic polymers were used in numerous attempts to synthesize bioinspired silica. The conceptual framework to understand the role of the polymers in these reactions varied from a role for the positively charged groups along the polymer chain in bringing silicon monomers close enough for further condensation to the formation of nanoscopic hybrid particles that are made of silica and polymers. Importantly, the physical phenomenon of phase separation was invoked several times as a possible regulator of biological and bioinspired silicification. It was suggested both as a morphogenesis process to yield the delicate nano-patterning of diatom silica, and as a chemical process that drives the system into reactive chemical phases. However, without a clear understanding of the players and conditions that cause phase separation, these ideas are too vague to establish a practical working scheme. In parallel scientific disciplines, liquid-liquid phase separation (or coacervation) processes have been shown to play important roles in biology and chemistry. During biological processes, liquid-liquid phase separations have been shown as a strategy to compartmentalize chemical reactions and protect cellular materials. In chemical syntheses, coacervate-directed crystallization was achieved.

There is a need in the art to efficiently prepare and control the nanoscale morphologies and compositions of silica products in polymer-induced silicifications.

The inventors of the present invention have found that the formation of distinct silica morphologies could be achieved by controlling the process of polycation-polyanion phase separation. Polycation-polyanion phase separation functions as the initial step in the silicification process, and that the sensitivity of the dense phase to ionic strength further affects the nanoscale morphologies of bioinspired silica.

### SUMMARY OF THE INVENTION

The invention provides a silicification process utilizing polycation-polyanion-soluble silicon systems and capable of controlling the morphology and composition of the silica products.

Thus, the invention provides in its first aspect a system comprising at least one polyanion, at least one polycation, at least one Si source and optionally at least one ionic solution, for use in the control of morphology of precipitated silica.

When referring to the “morphology of precipitated silica” it should be understood to relate to the structure of the precipitated silica, being either spheres, network or coalescence. The system and process of the invention allow for the control of the resulting morphology of the precipitated silica.

In the context of the present invention the term “polyanion” should be understood to encompass any polymer (organic or inorganic, synthetic, semisynthetic or naturally occurring) having multiple anionic moieties (located on any part of the polymer they are connected to and can be either directly on atoms of the polymer chain or as a functional charged group substituted on the polymer chain).

In the context of the present invention the term “polycation” should be understood to encompass any polymer (organic or inorganic, synthetic, semisynthetic or naturally occurring) having multiple cationic moieties (located on any part of the polymer they are connected to and can be either directly on atoms of the polymer chain or as a functional charged group substituted on the polymer chain).

When referring to “Si source” it should be understood to relate to any type of silicon source, that provides the reaction taken place with a system of the invention of silicon ions for the precipitation of silica. For example Si source can be soluble silicic acid (Si(OH)₄), (which can be, for example, obtained through dilution and acidification of a sodium silicate ((NaOH)ₓ(Na₂SiO₃)_{y}·zH₂O) solution). In some embodiments, the silicon source is a natural silicon source. In other embodiments said silicon source is from a synthetic source (such as for example alkoxysilanes).

The term “ionic solution” should be understood to encompass any type of solution (inorganic or organic or any combination thereof) that comprise ions. The “ionic strength” of a solution is a measure of the concentration of ions in that solution. Ionic compounds, when dissolved in water, dissociate into ions. The total electrolyte concentration in solution affects important properties such as the dissociation constant or the solubility of different salts. One of the main characteristics of a solution with dissolved ions is the ionic strength. Ionic strength can be molar (mol/L solution) or molal (mol/kg solvent) and to avoid confusion the units should be stated explicitly.

In some embodiments, said at least one Si source is mixed with at least one of polyanion prior to the addition of said at least one polycation. In other embodiments, said at least one Si source is mixed with at least one of polycation prior to the addition of said at least one polyanion.

In some embodiments, said at least one polyanion and at least one polycation are mixed prior to the addition of said at least one Si source.

In some embodiments, said at least one ionic solution is added to either said at least one polyanion or polycation prior to the addition of said Si source.

In some embodiments, said at least one ionic solution is added to said at least one polyanion prior to the addition of said at least one polycation.

In some embodiments, said at least one ionic solution is added to said at least one polycation prior to the addition of said at least one polyanion.

In some embodiments, said polyanion is selected from an organic polyanion, an inorganic polyanion, an organic/inorganic polyanion and any combinations thereof.

In some embodiments, said polycation is selected from an organic polycation, an inorganic polycation, an organic/inorganic polycation and any combinations thereof.

In some embodiments, said at least one Si source is selected from at least one organic Si source, at least one inorganic Si source and any combination thereof.

In some embodiments, said at least one ionic solution is an aqueous ionic solution.

In some embodiments, said at least one ionic solution is a non-aqueous ionic solution.

In some embodiments, said at least one ionic solution provides said system an ionic strength capable of phase separating said at least one polyanion and at least one polycation.

The invention further provides a process for controlling the morphology of precipitated silica comprising the step of mixing (i) at least one first polyion, being at least one polycation or at least one polyanion, optionally in the presence at least one ionic solution with (ii) at least one second polyion, being the corresponding opposite polyion of said first polyion; and with at least one Si source; wherein said at least one Si source can be added either prior to mixing said first and second polyions or after mixing said first and second polyions; thereby precipitating silica with a specific morphology.

The term “polyion” as used herein refers to any polymer (organic or inorganic, synthetic, semisynthetic or naturally occurring) having multiple ionic charged moieties (either anionic, thereby said polyion is a polyanion or cationic, thereby said polyion is a polycation) which are located on any part of the polymer they are connected to and can be either directly on atoms of the polymer chain or as a functional charged group substituted on the polymer chain.

In some embodiments, said at least one first polyion is at least one poly cation and at least one second polyion is at least one poly anion.

In some embodiments, wherein said at least one first polyion is at least one poly anion and at least one second polyion is at least one poly cation.

In some embodiments, said at least one first polyion is in the presence of at least one ionic solution.

In some embodiments, said Si source is added prior to mixing said first and second polyions.

In some embodiments, said Si source is added after mixing said first and second polyions.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1a-1e. (1a-1c) show the kinetics of polymer-silica and polymer-polymer precipitation detected by DLS measurements in solutions containing the indicated concentrations of polymers and Si. (1d) Images of samples corresponding to panel (1c) after 24 h, showing the formation of silica-gel (5 mM PAA, blue), silica-precipitate (5 mM PAH+5 mM PAA, purple), and a solution in a stabilized silica-sol (5 mM PAH, red). (1e) SEM images of lyophilized precipitates of the same samples after 48 h, showing a granular texture for the dried silica gels (single polymer), and spherical particles in the presence of both PAH-PAA.

FIGS. 2a-2b. (2a) A scheme illustrating the Reaction Sequences. Each step that yields visible precipitates has a numerical label that is used throughout this manuscript. (2b) SEM images showing the morphologies of collected samples after centrifugation and lyophilization.

FIGS. 3a-3d. Chemical composition of the Si-containing precipitates. (3a) High resolution XPS spectra of the Si 2p, N 1s, and Na Is regions collected from samples with 10 mM and 100 mM Si. (3b) Si to total polymer (PAH+PAA) mole ratios derived from XPS data. See Table 3 for detailed elemental compositions. (3c, 3d) Bulk composition analyses of total extracted Si(3c) and TGA (1d, inserts show the inorganics weight fraction). Reaction conditions can be found in Table 2 according to the sample labels.

FIGS. 4a-4b. (4a) Cryo-TEM images revealing the native-state of the polymer and silica precipitates. Reaction conditions are identical to FIG. 2 (using the same color code and numerical labels). 4 (b) Particle sizes obtained from the TEM images analyses (N=100 for each sample).

FIG. 5. Morphological changes upon dehydration of the polymer dense phases. The effect of irradiation at cryo-TEM on the polymer dense phases of Reaction Sequences I (No. 1) and III (No. 9) (left and middle panels) showing that Reaction Sequence III particles dry into porous structures. Conventional TEM images of the corresponding air-dried samples (right panels) confirm that Reaction Sequence III particles have net-like meso-structures. Note that in contrast to SEM samples, the TEM samples were not centrifuged and washed, thus condensation and particle fusion were inhibited, leading to smaller and distinct particles.

FIG. 6. SEM images of the precipitates induced by various polymer pairs under low and high ionic strength conditions, with and without presence of Si. Spheres and networks formed at the low and high ionic strength irrespective of the presence of silica sources.

FIGS. 7a-71. Raw DLS correlograms for soluble silica solutions with increasing [Si(OH)₄] concentrations (0 mM (7a, 7d, 7g. 7j), 10 mM (7b, 7e, 7h, 7k), 100 mM (7c, 7f, 7i, 7l)) and added polymers (no polymers (7a, 7b, 7c), 5 mM PAH (7d. 7e, 7f), 5 mM PAA (7g. 7h, 7i) and 5 mM PAH+5 mM PAA (7j. 7k, 7l)) measured at different time points. Each measurement consists of three replicates. The correlation coefficient increases with time in the 10 mM Si(OH)₄ due to the formation of silica colloids, while in the 100 mM Si(OH)₄ eventual decrease represents silica-gelation.

FIGS. 8a-8b. Optical microscopy images of coacervates forming in 5 mM PAH and 5 mM PAA with (8a) 75 mM, and (8b) 3 M NaCl, showing that ultrahigh concentration of NaCl inhibits PAH-PAA coacervation. White arrow in 8(a) highlights PAH-PAA coacervates.

FIGS. 9a-9l. Particle sizes measured by DLS. Particle size distributions under different conditions labeled by numbers in the top right corners of each diagram. Reaction conditions can be found in Table 2 according to the sample labels. These results are in agreement with the cryo-TEM observations (FIG. 4).

FIGS. 10a-10f. The relative speciation distributions of (10a) mono silicic acid (Si(OH)₄), (10b) poly silicic acid (pSi), (10c) PAH, (10d) PEI, (10e) PAA and (10f) phosphate (P). The components were calculated based on pKa values of 9.9, 6.8, 8.9, 7.5, 4.5, and 2.1 for Si(OH)₄, pSi, PAH, PEI, PAA, and P, respectively.

FIGS. 11a-11f. A polymer phase separation system that concentrates silica in the dense phase. (11a) The experimental pipeline consisting of three stages. 11b-11d) Light microscopy images of the various stages of the process. Note that the macroscopic dense phase in 11c, 11d concentrates the silica tracker dye PDMPO (green) when silica precursors are introduced to the dilute phase. (11e) The amount of silica inside the polymer dense phase after incubation with a dilute phase containing 100 mM dissolved Na₂SiO₃ in PEI. (11f) Analyses of the amount of incombustible inorganic content (mainly silica) present in lyophilized dense phases.

FIGS. 12a-12i. Si concentrations within the polymer dense phase. (12a-12c) Experiments of dense phase silicification with variable ‘Si’ concentrations in the dilute phase. The measured amount of silica extracted from the dense phase after 72 hours (12a), and its volume (12b), are used to calculate the concentration of silica in the dense phase (12c). (12d-12i) Similar experiments with a constant Si concentration and variable ionic strength (12d-12f), or pH (12g-12i) of the dilute phase. As in all cases the silica species are collectively referred to as ‘Si’.

FIGS. 13a-13i. Precipitation of insoluble silica inside the dense phase. (13a) The modified experimental set-up where an elution step is added to measure the amount of soluble silica that can diffuse out of the dense phase. (13b) The cumulative amount of eluted silica, measured every 24 hours when refreshing the Si-free dilute phase. (13c) The amount of soluble silica (eluted during 5 days), and total silica after various silicification times. The % soluble is plotted by the floating markers. (13d) The amount of soluble silica as a function of ionic strength in the dilute phase. (13e) A further modification to the experimental set-up where the silicification step is divided into two steps with different pH. (13f) The amount of soluble silica (eluted during 5 days) and total silica after silicification with various pH changes. (13g) The amount of soluble silica at pH=8 as a function of ionic strength in the dilute phase. (13h, 13i) SEM images of freeze-dried silicified samples following maturation under different pH values.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Two polymers were used, poly (allylamine hydrochloride) (PAH, Mw˜50 kDa) and poly (acrylic acid) (PAA, Mw˜15 kDa), to serve as model polycation and polyanion (Scheme 1 below).

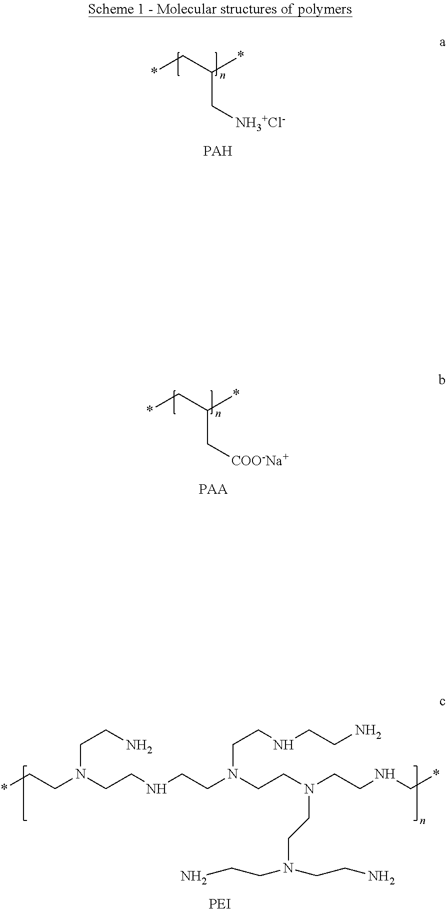

The silicon source, soluble silicic acid (Si(OH)₄), was obtained through dilution and acidification of a sodium silicate ((NaOH)ₓ(Na₂SiO₃)_{y}·zH₂O) solution. This silicon source can better represent natural silicon sources than the widely used alkoxysilanes that catalytically break into soluble silicon and organic solvents. The experiments were conducted at pH 5.0 since it is estimated to be the physiological pH during bio-silicification.

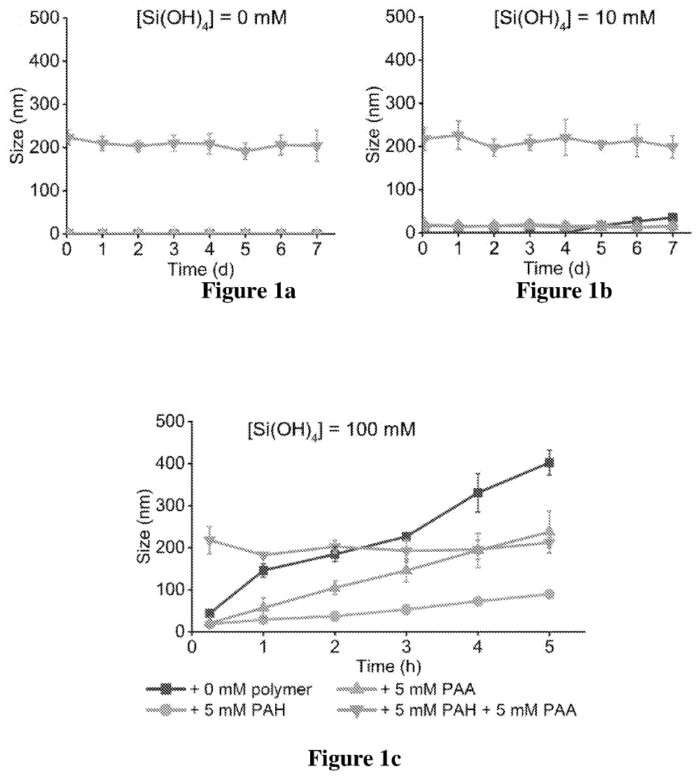

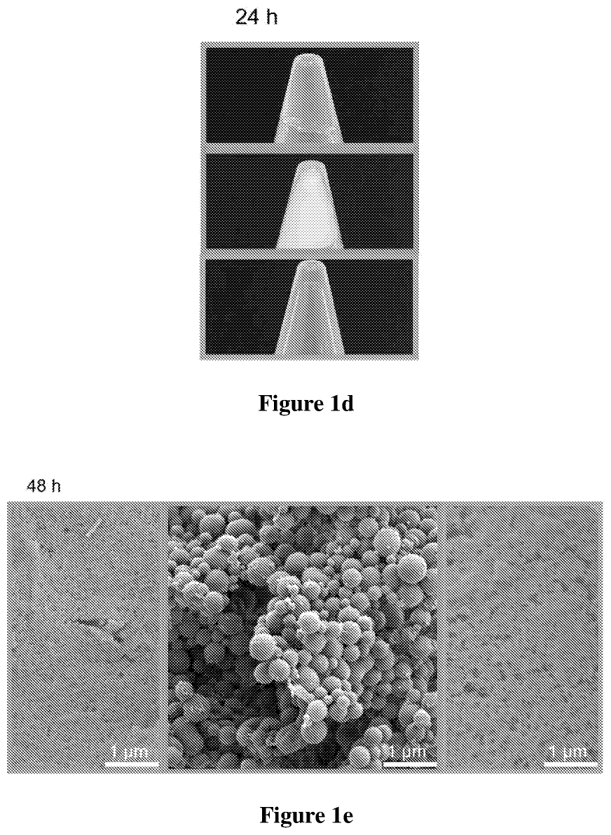

Aggregation of the polymers was evaluated by dynamic light scattering (DLS) before studying polymer-induced silicification. No particles were detected in 5 mM PAH or PAA (FIG. 1a), that is, the soluble polymers do not significantly scatter light. Under low Si concentration (10 mM, σ=0.71 with respect to amorphous silica, σ is the supersaturation index, Table 1), a 4-day induction period was needed for the formation of growing silica colloids in the absence of the polymers. On the other hand, the presence of either polymer led to the immediate formation of stable nanometer size clusters that do not coalesce to form a gel (FIG. 1b). At a higher Si concentration (100 mM, σ=1.73), silica gelation occurred within few hours in the absence of the polymers (FIG. 1c). The addition of the polymers slowed down the process, with PAH showing a relatively higher stabilizing effect of the silica sol, compared to PAA (FIG. 1d). Nevertheless, after 48 hours, silica hydrogel formed in all of these samples (FIG. 1e). In contrast to the concentration-dependent interactions between each polymer and silicon, when both PAH and PAA were added to the soluble silicon solution, the result always was the immediate formation of stable colloids (FIG. 1a-1c). Irrespective of Si concentration, the colloids that formed in the presence of the two polymers had distinct macroscopic texture (FIG. 1d), and microscopic particulate morphology (FIG. 1e), suggesting that the single PAH or PAA function as inhibitors of the sol-gel process, but the presence of both of them together diverted the sol-gel process into a different chemical pathway.

TABLE 1
PHREEQC simulating saturation indices with respect to various
possible SiO₂-phases in Si(OH)₄ solutions at pH 5.0, 25° C.

| | | | | Saturation indices | | |
|---|---|---|---|---|---|---|
| [Si(OH)₄] | Activity (mM) | | | | SiO₂ | Amorphous |
| (mM) | Si(OH)₄ | Si(OH)₃O⁻ | Si(OH)₂O₂²⁻ | Quartz | gel | SiO₂ |
| 10 | 10 | 1.62 × 10⁻⁴ | 1.42 × 10⁻¹² | 1.98 | 1.02 | 0.71 |
| 100 | 100 | 1.92 × 10⁻³ | 2.46 × 10⁻¹¹ | 3.00 | 2.03 | 1.73 |

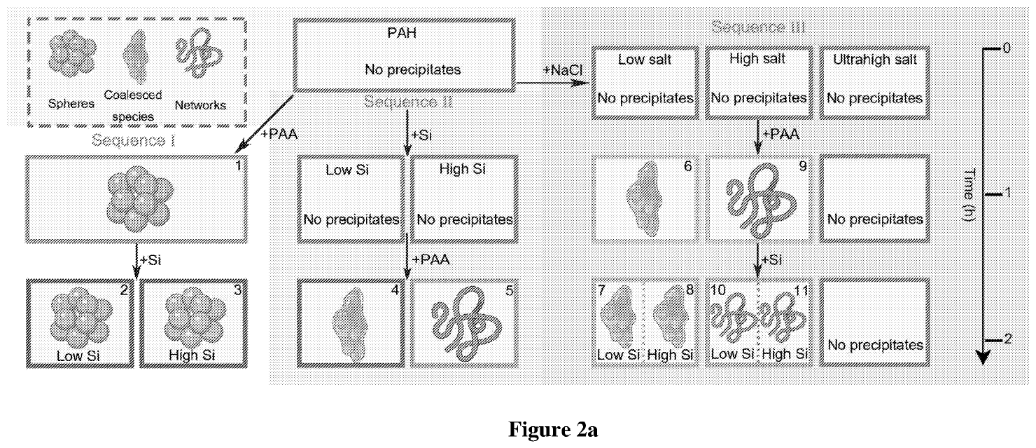

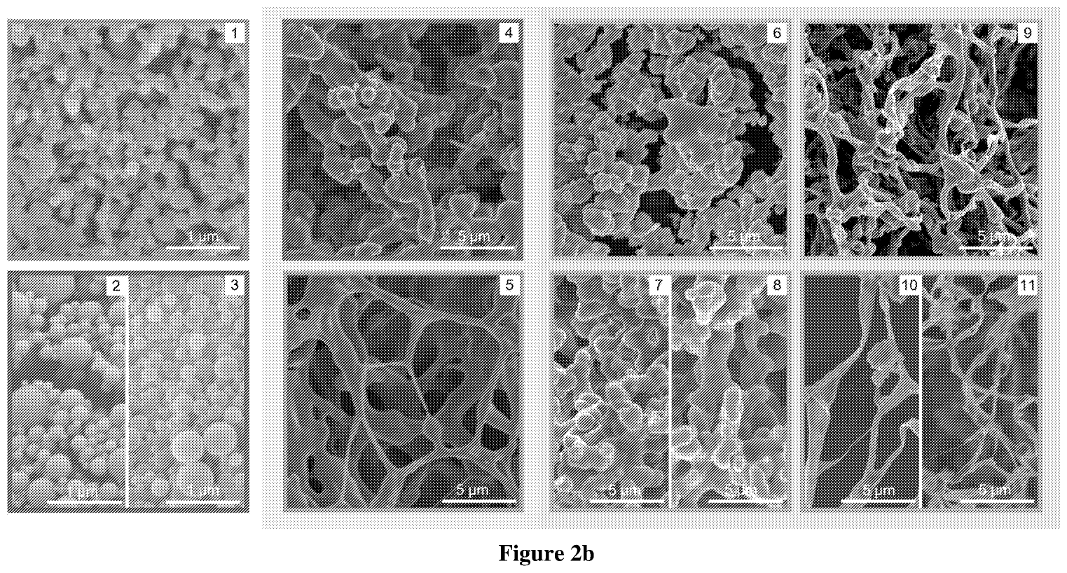

The particles that formed in the presence of the two polymers and Si are dense, and better represent bio-silica than the single-polymer silica gels. Additionally, a previous study of a similar system suggested that phase separation of Si and the polycation molecules results in different morphologies of the final silica products. To study this notion in detail, the reaction sequence of the two-polymer silicification was divided into two: Reaction Sequence I-PAH→PAA→Si(allowing PAH to react with PAA first and then adding soluble Si), and Reaction Sequence II-PAH→Si→PAA (mixing PAH with soluble silicon and then adding PAA) (FIG. 2a). Examining the precipitates of all stages of Reaction Sequence I with a scanning electron microscope (SEM) showed spherical particles, irrespective of the silicic acid concentration, which is in agreement with the DLS results (FIGS. 1b, 1c). This suggests that the morphologies of Reaction Sequence I precipitates are independent of Si concentrations. In contrast to Reaction Sequence I, Reaction Sequence II yielded precipitates only after adding PAA (the PAH-Si colloids were stable from aggregation, FIG. 1c), and Si concentrations changed the morphologies of the precipitated silica from coalescent agglomerates at the low Si concentration, to networks at the high Si concentration (FIG. 2b). It is important to note that a clear hexagonal pattern was not observed, as was previously proposed for similar sequence pair. Altogether, these results confirm that the reaction sequence affects the morphologies of the final precipitates.

A possibly overlooked difference between Reaction Sequence I and II is the conditions at which liquid-liquid phase separation of the two polymers occurs. In Reaction Sequence I, the polymers interact at low ionic strength, whereas in Reaction Sequence II, because of the added silicic acid solution, the polymers interact at a much higher ionic strength. The effect of ionic strength on the morphology of the final precipitates was investigated by creating Reaction Sequence III-PAH→NaCl→PAA→Si. In Reaction Sequence III, different concentrations of NaCl are added to the PAH solution, yielding various ionic strength conditions under which PAH reacts with PAA. ‘Low’ (7.5 mM) and ‘high’ (75 mM) NaCl concentrations were added, corresponding to the ionic strength of the two Si concentrations that were used in Reaction Sequence II (Table 2).

Surprisingly, even though silicic acid was added at the end, as in Reaction Sequence I, the morphology of the precipitates of Reaction Sequence III was very similar to Reaction Sequence II. Importantly, the coalescent agglomerates and networks were observed once the polymers phase separated to form dense phases, even before silica addition (FIG. 2b). Adding soluble silicon for silicification after phase separation did not influence their morphologies (FIG. 2b).

TABLE 2
Nominal concentrations of the components in FIG. 2b.

| | | Solution components (mM) | | | | |
|---|---|---|---|---|---|---|
| No. | Samples | [PAH] | [PAA] | [Si(OH)₄] | [Na⁺] | [Cl⁻] |
| 1 | PAH→PAA | 5 | 5 | 0 | 5.7 | 5.4 |
| 2 | PAH→PAA→Si (low) | 5 | 5 | 10 | 13.5 | 11.7 |
| 3 | PAH→PAA→Si (high) | 5 | 5 | 100 | 83.2 | 77.8 |
| 4 | PAH→Si (low)→PAA | 5 | 5 | 10 | 13.5 | 11.7 |
| 5 | PAH→Si (high)→PAA | 5 | 5 | 100 | 83.2 | 77.8 |
| 6 | PAH→NaCl (low)→PAA | 5 | 5 | 0 | 13.2 | 12.9 |
| 7 | PAH→NaCl (low)→PAA→Si (low) | 5 | 5 | 10 | 21.0 | 19.2 |
| 8 | PAH→NaCl (low)→PAA→Si (high) | 5 | 5 | 100 | 90.7 | 85.3 |
| 9 | PAH→NaCl (high)→PAA | 5 | 5 | 0 | 80.7 | 80.4 |
| 10 | PAH→NaCl (high)→PAA→Si (low) | 5 | 5 | 10 | 88.5 | 86.7 |
| 11 | PAH→NaCl (high)→PAA→Si (high) | 5 | 5 | 100 | 157.9 | 152.8 |

(pH 5.0, 25° C., σ[Si (low)] = 0.71, σ[Si (high)] = 1.73)
Note that Na and Cl ions originate from the polymer and silicon stock solutions, as well as from the addition of NaCl and pH adjustment.

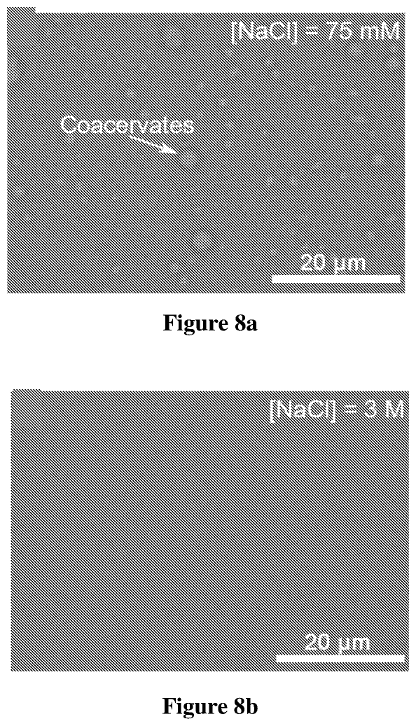

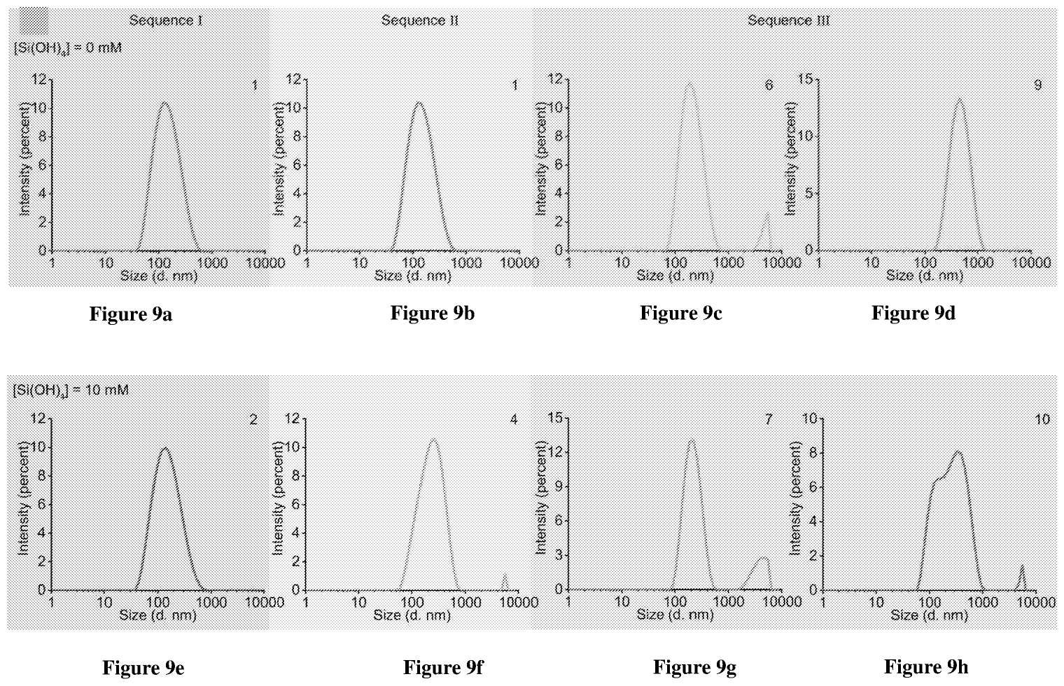

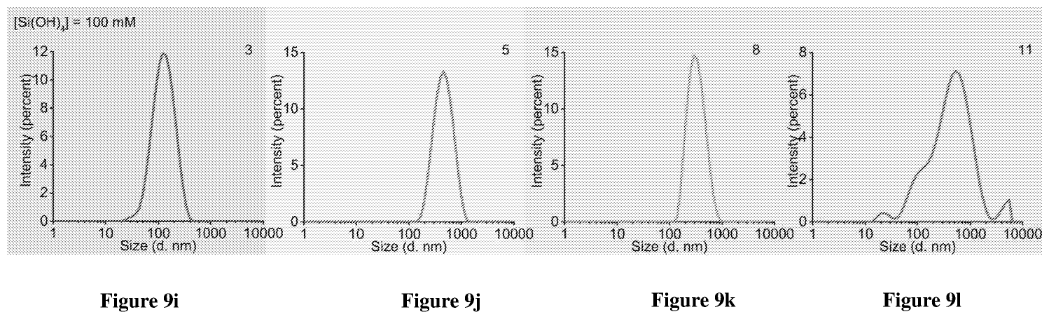

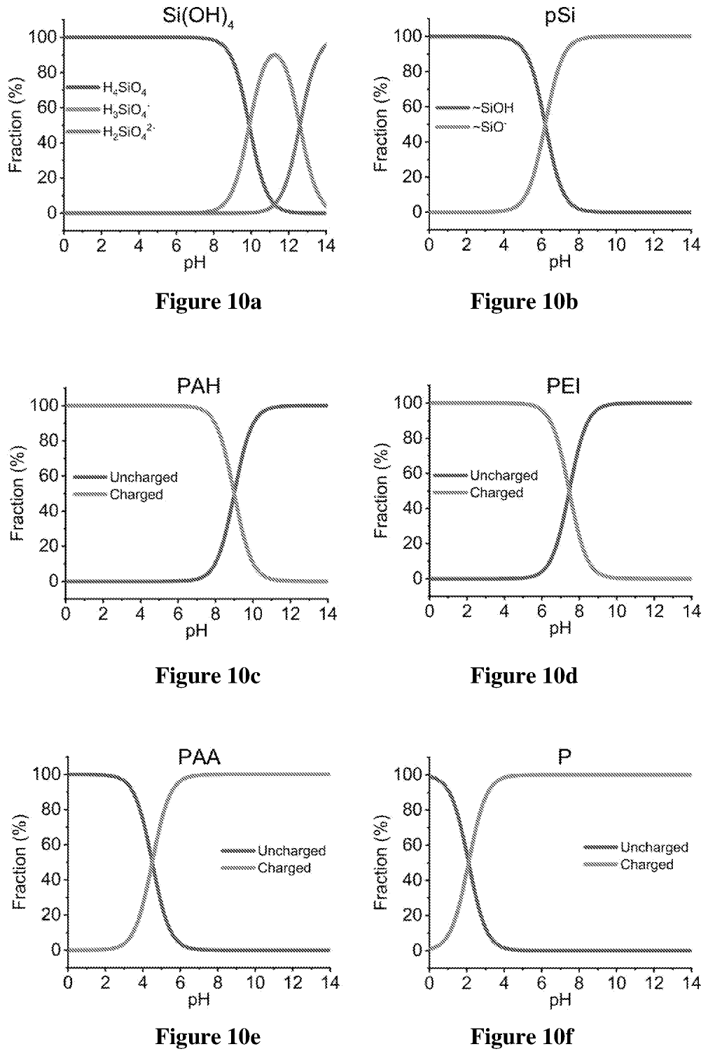

Thus, it is the PAH-PAA phase separation rather than silicification that determines the final morphologies of the precipitated silica. This notion is further supported by the fact that increasing the [NaCl] to 3M, a concentration that allows complete mixing of the polymers, so phase separation is inhibited (FIG. 8), no silica precipitation was observed within the 2 h of the experiment (FIG. 2a). This observation suggests that phase separation is a prerequisite for the silica-precipitating function of the polymers.

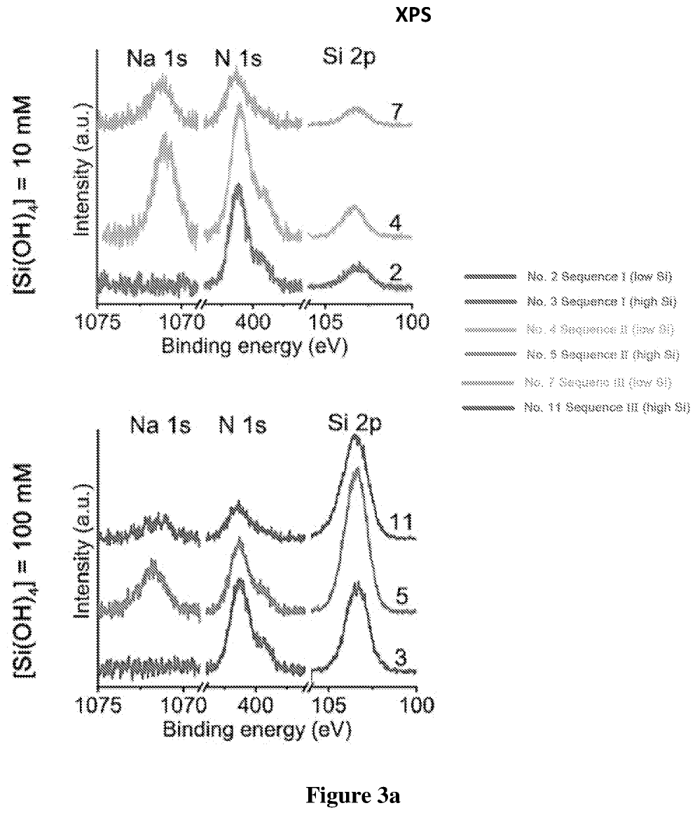

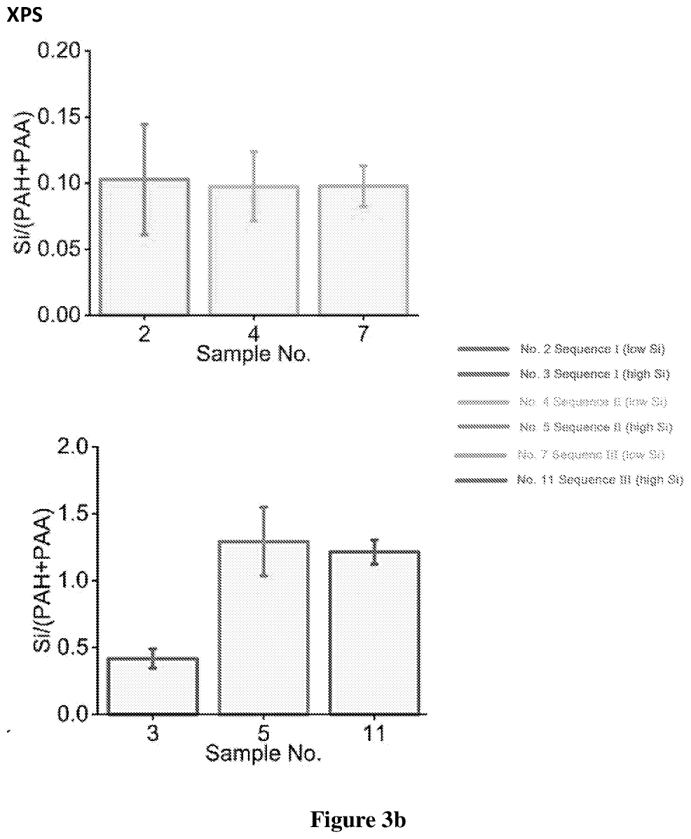

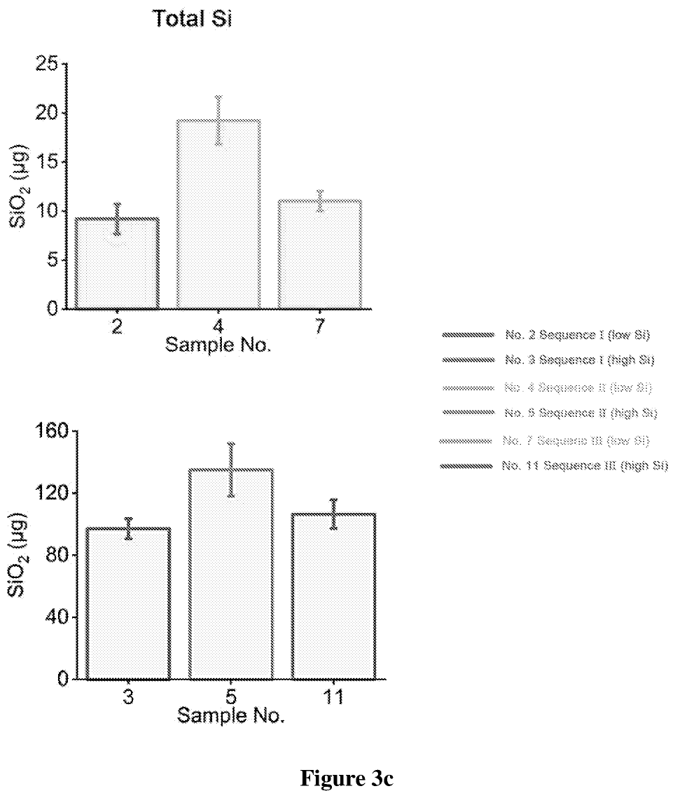

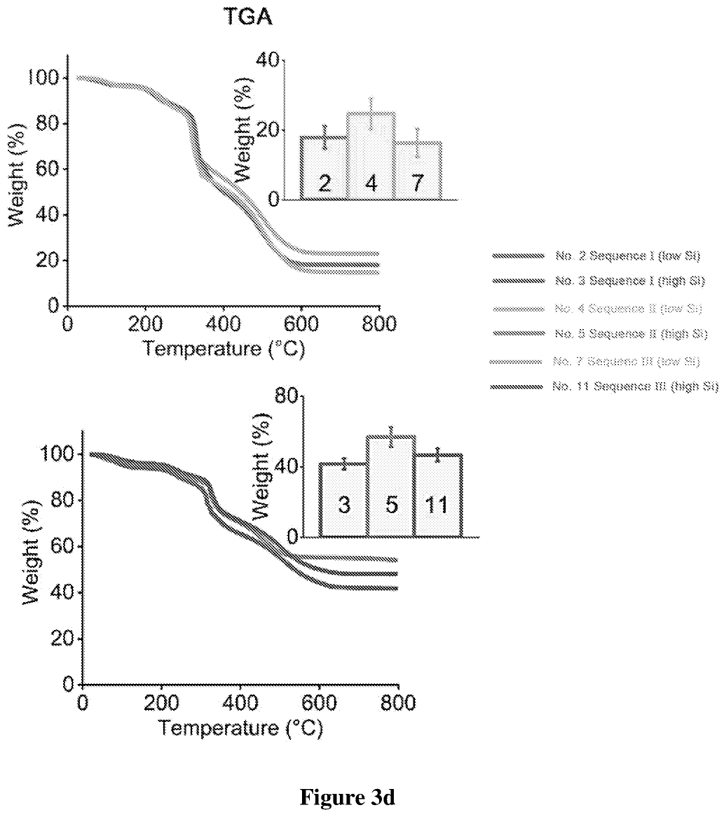

X-ray photoelectron spectroscopy (XPS) was used to quantify the elemental compositions on the surface of the dried silica precipitates. All samples consist of C, O, N, Si, Cl, and usually Na (FIG. 3a, Table 3). Intensities of nitrogen and carboxylic carbon peaks were used to quantify the concentrations of PAH and PAA, respectively, and then the mole ratio of Si to total polymer (PAH+PAA) (FIG. 3b). At the low Si concentration, this ratio is ˜0.1 and similar between all Reaction Sequences, indicating a dominant organic fraction in the dense phase. At the high Si concentration, Reaction Sequences II and III are more silicified than Reaction Sequence I, reaching a molar fraction of about 1:1 between Si and organic functional groups. This suggests that both higher Si concentration and phase separation that occurs under high ionic strength results in more efficient silica precipitation.

The XPS analysis that shows surface content was complemented with two bulk analyses. First, the total amount of precipitated silica was quantified by measuring Si concentration after complete dissolution of the precipitates. This showed that higher Si concentrations in the medium are roughly linearly correlated to higher silicification efficiency (FIG. 3c). Thermogravimetric analysis (TGA) that can relate the ratio between the organic and inorganic fractions of the precipitates (FIG. 3d) was further performed. These analyses confirmed that Si content is varying between 20% and 50%, in agreement with the XPS results. These results suggest that in contrast to the morphology that is mostly affected by the polymer phase separation, the composition of the dried precipitates is primarily dictated by Si concentration. In addition, allowing PAH to react with soluble silicon first (Reaction Sequence II) results in the highest efficiency of precipitating silica.

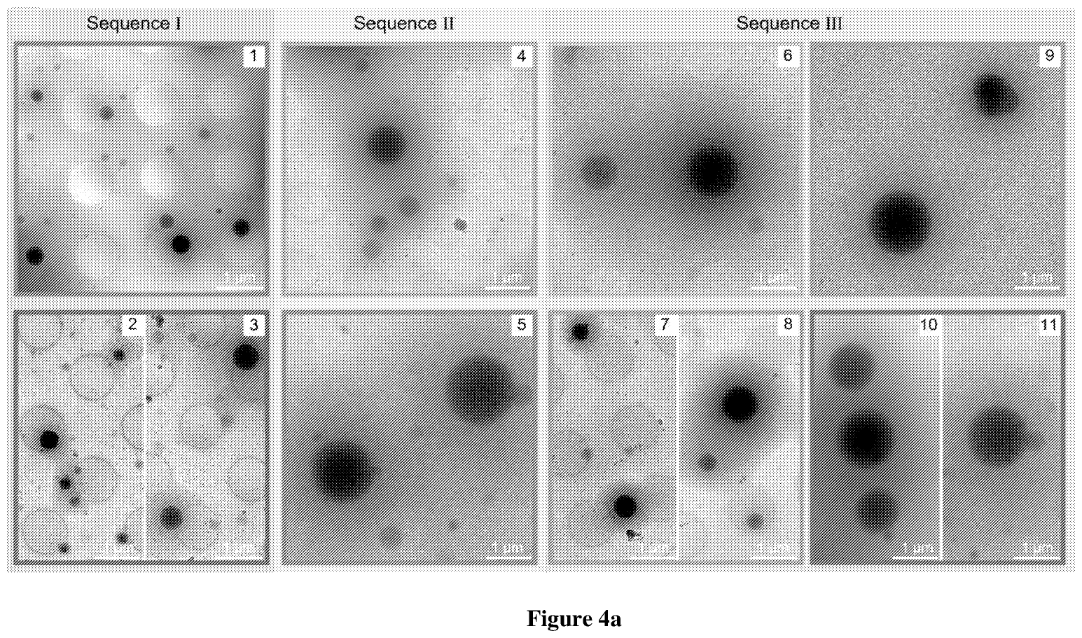

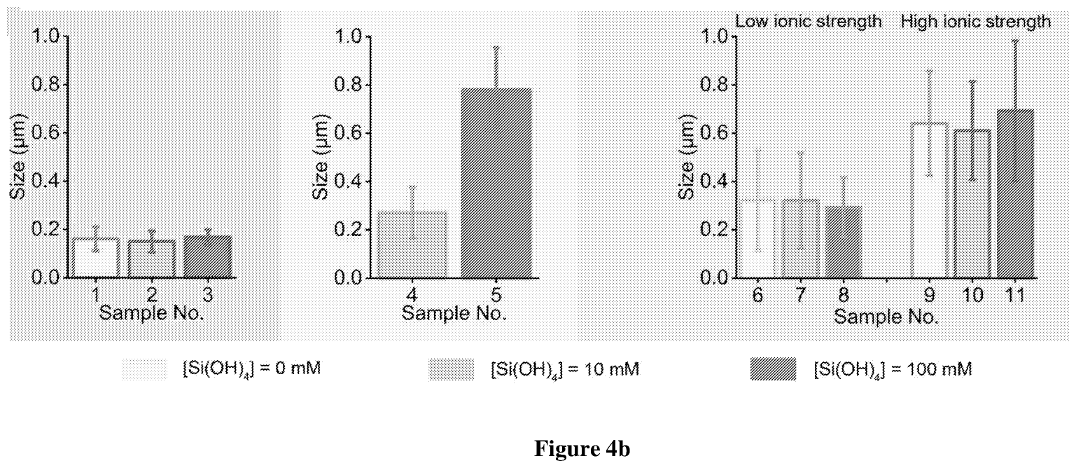

Investigating dried reaction products with imaging and analytical techniques is the most straightforward approach to study aqueous silicification. Nevertheless, the similar morphologies that were observed even without any added Si(FIG. 2), prompted to hypothesize that drying might affect the observed morphologies. In order to investigate the native-state structure in situ, the reaction solution was vitrified on a transmission electron microscope (TEM) grid and observed using cryo-TEM (FIG. 4a). Surprisingly, the images show that the primary structure of all precipitates is of dense spherical particles within a dilute matrix. The difference between the various Reaction Sequences is in particle size, where high ionic strength leads to the formation of larger particles irrespective of the stage at which Si is introduced (FIG. 4b).

TABLE 3
XPS elemental analyses of silica-precipitates induced
by PAH-PAA polymer-dense phases.

| | ATOMIC CONCENTRATIONS (%) | | | | | | |
|---|---|---|---|---|---|---|---|
| SAMPLE | Reaction | | | | | | |
| NO. | Sequence | C | O | N | Si | Cl | NA |
| 2 | PAH→PAA→ | 63.35 ± | 25.21 ± | 7.59 ± | 3.35 ± | 0.31 ± | 0.04 ± |
| | Si(low) | 4.71 | 3.11 | 0.94 | 2.54 | 0.08 | 0.08 |
| 3 | PAH→PAA→ | 49.21 ± | 33.94 ± | 8.35 ± | 6.78 ±± | 1.45 ± | 0.09 ± |
| | Si(high) | 2.90 | 3.20 | 0.63 | 0.81 | 0.49 | 0.10 |
| 4 | PAH→Si(low)→ | 63.32 ± | 24.16 ± | 8.79 ± | 1.87 ± | 1.07 ± | 0.67 ± |
| | PAA | 1.25 | 1.26 | 0.22 | 0.55 | 0.14 | 0.13 |
| 5 | PAH→Si(high)→ | 35.58 ± | 44.45 ± | 4.99 ± | 13.27 ± | 1.00 ± | 0.58 ± |
| | PAA | 2.43 | 2.55 | 0.58 | 1.97 | 0.10 | 0.12 |
| 7 | PAH→NaCl(high)→ | 33.05 ± | 46.84 ± | 4.14 ± | 14.63 ± | 0.67 ± | 0.56 ± |
| | PAA→Si (high) | 1.57 | 1.56 | 0.30 | 1.50 | 0.12 | 0.15 |
| 11 | PAH→NaCl | 63.88 ± | 24.16 ± | 7.76 ± | 2.01 ± | 1.22 ± | 0.85 ± |
| | (low)→PAA→ | 1.84 | 1.78 | 0.34 | 0.26 | 0.15 | 0.18 |
| | Si (low) | | | | | | |

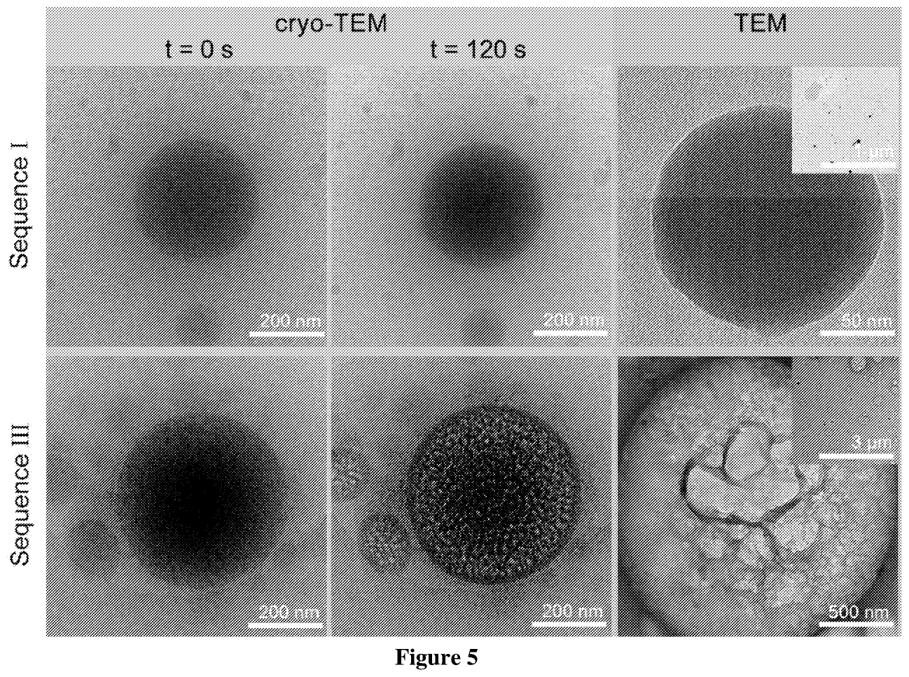

The influence of hydration level and composition on the differences between the Reaction Sequences is manifested by the behavior of the dense particles under the electron beam. After 120 s of irradiation at cryo conditions, Reaction Sequence I particles were stable under the beam, whereas at the same irradiation conditions pores formed inside the Reaction Sequence III particles (FIG. 5). This difference can be related to higher hydration level of Reaction Sequence III particles, which sublime into porous structures. This reasoning is further validated by images of ex situ dried samples (similar to the SEM imaging). These room temperature TEM images show that dried Reaction Sequence I particles are still in the form of dense spheres, whereas dried Reaction Sequence III particles show net-like meso-structures (FIG. 5). It was concluded that the morphological differences between the native structure (cryo-TEM, FIGS. 4, 5) and dried structure (SEM and TEM, FIGS. 2, 5) is due to the drying procedure that involves centrifugation and lyophilization.

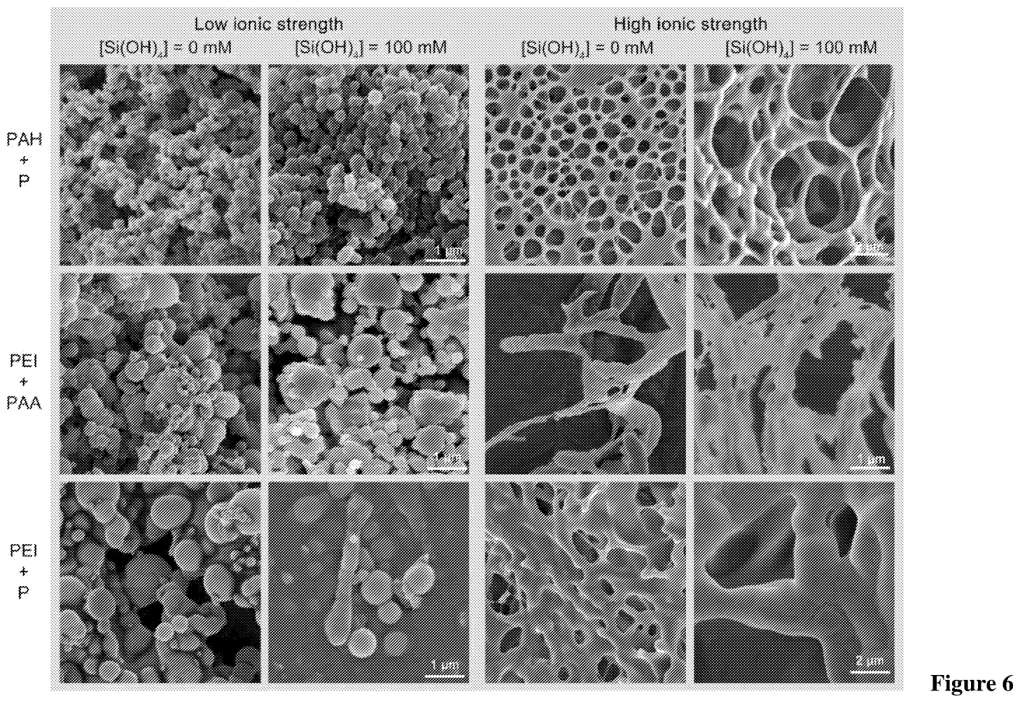

To test whether the influence of polymer phase separation on silicification is a universal phenomenon, PAA and PAH were replaced with phosphate ions and branched polyethyleneimine (PEI, Mw˜ 750 kDa), yielding three new pairs of oppositely charged molecules: PAH-phosphate, PEI-PAA, and PEI-phosphate. Similar silicification experiments were conducted and morphologies of dried precipitates were examined. All different pairs show a similar behavior to the initial PAH-PAA pair: at low ionic strength the precipitates are spherical particles and at high ionic strength they are networks, regardless of the extent of silicification (FIG. 6). Even though the trend is similar, each pair required a calibration of the ionic strength conditions that result in each morphology (concentrations used in the experimental reactions are shown in Tables 3 and 4). For the PAH-phosphate pair, higher NaCl concentration is needed for inducing the change from silica spheres to networks, whereas a lower NaCl concentration is needed in the PEI-PAA system, necessitating ‘salting out’ of the polymers with dialysis (see Experimental section). These differences in ionic strength values can be explained by the stronger electrostatic interactions of phosphate\PAH compared to PAA\PEI (see charged species distribution, FIG. 5), requiring more salt to weaken the reactions between PAH and phosphate. In other words, charge attraction between PEI and PAA is the weakest, leading to the formation of spherical coacervates at the lowest ionic strength, and interactions between PAH and phosphate are the strongest, requiring the highest ionic strength to produce networks. Thus, the stronger electrostatic attractions between polycations and polyanions lead to the formation of spheres and the weaker binding contributes to the formation of the networks.

Nanopatterning of inorganic materials is a challenging nanotechnological goal, and the ability of organisms to sculpt such materials with species-specific fidelity has been a rewarding inspiration source. In the case of silica patterning, both in vivo and in vitro, liquid-liquid phase separation has been proposed to play crucial roles. However, the scientific attention was focused on the interactions between the Si precursors and polymers. Here, it was shown that an initial phase separation of oppositely charged polymers followed by subsequent silicification is the mechanism underlying the mineralization process. This is evidenced by the similar morphologies of polymer precipitates with and without silica (FIG. 2), demonstrating that the polymer dense phase serves as a facilitator of silicification. Furthermore, in situ characterization by cryo-TEM shows the primary structure of these dense phases and their sensitivity to ionic strength (FIGS. 4 and 5).

Ionic strength, in addition to other chemical and physical properties, is a key parameter in liquid-liquid phase separation of oppositely charged polymers. High ionic strength leads to charge screening and weakening of the electrostatic interactions, giving rise to more hydrated and less dense polymer condensates. Therefore, different morphologies of dried silicification products that were observed, reflect foremost the effect of drying a highly hydrated hybrid structure, rather than differential interactions of silica precursor with the different polymers. The more hydrated the dense phase is in solution, the higher the tendency of its native spherical shape to transform into networks upon drying (FIG. 5). Besides the morphological regulation, phase separation that occurs under different ionic strength conditions affects silica content and composition. Reaction Sequence II yields the highest Si content (FIG. 3).

Mineralization based on polymer phase separation could be a general approach for material synthesis, as the liquid-like polymer dense phases have the potential to adopt engineered morphologies and compositions. However, the degree of mineralization can be the most challenging aspect of this approach. In the model system, hybrid materials were produced with a maximum of ˜50% silica content. It is possible that tailored reaction conditions and other polymers will be able to enhance silicification degree to around 90%, which is similar to biosilica. In this context it is interesting to note that previous bioinspired silicification products reported in the literature were rarely characterized for their silica fraction, and for the reported data silica content varied from 20% to 80%.

These findings also suggest a fresh view on the mechanism underlying the biological silicification of diatoms. Diatoms take up and accumulate stabilized intracellular Si in the range of hundreds of mM, strongly exceeding silica saturation in dilute solution ([Si(OH)₄]˜2 mM), and control its polymerization inside dedicated organelles. In the in vitro experimental system, PAH stabilized similar concentration of Si from gelation (even though for time periods of only days, FIG. 1c), and the polymer dense phase serves as a host for silicification in a way that can be analogous to the silicifying organelle. In a wider perspective, it is possible that the widespread correlation between polycationic polymers and biosilica formation is related to the need to concentrate and stabilize Si, and the role of the negatively charged proteins is to transform the polycation-stabilized Si into a polymer dense phase that facilitates silica polymerization. Another dominant example are sponges, a group of silicifying organisms, in which LCPAs are present. Nevertheless, sponge silicification may fundamentally differ as silicateins, enzymes that catalytically condense silica, are pivotal.

Formation of inorganic materials from soluble building blocks is fundamental to biological systems and technological applications alike. It is established that in addition to the classical monomer-by-monomer growth process, a myriad of multi-step alternatives exists. A common feature of these ‘non-classical’ mineralization processes is that they occur at conditions that are far from equilibrium and often involve additives that serve as process-directing agents. In synthetic systems, highly supersaturated solutions are attainable by mixing concentrated solutions or using rapid chemical reactions that accumulate products. These conditions are usually incompatible with biological processes that need to occur within the general homeostasis of the cell. Therefore, when considering the two hallmarks of multi-step mineralization, a crowded environment and high supersaturation, they match very differently common cellular settings. On the one hand, the cellular environment is inherently crowded with functional macromolecules, but on the other hand, it is difficult to envision how cells concentrate the mineral building blocks to the needed supersaturation values allowing the formation of metastable phases.

On a wider perspective, controlling chemical reactions is a fundamental trait of biological systems, and organisms use various strategies to regulate where and when to activate a desired chemical process. One such strategy is the use of intracellular condensates, dense biopolymer phases that form through the physical process of liquid-liquid phase separation. These condensates create distinct chemical conditions, which localize chemical reactions to specific environments within the different phases. One outcome of the different chemical and physical properties within the dense condensate and in the surrounding dilute phase is that concentration gradients appear for ‘client’ molecules that diffuse freely between the dense and dilute phases to reach equilibrium. The magnitude of such a gradient and its direction is highly dependent on the specific chemistry of the system.

One of the most intriguing examples is the formation of silica at physiological conditions within cells, a process that is extremely different from the harsh chemical conditions that are used in industrial silica applications. A hallmark of biogenic silicification processes is the presence of oppositely charged polymers, cationic long-chain polyamines and negatively charged proteins, that can phase separate, forming a dense polymer-rich phase, or a coacervate, within a dilute matrix. Several bioinspired silicification experiments suggested that liquid-liquid phase separation is involved in various stages of the process, albeit not as a mandatory feature. But even though it was recently demonstrated that the polymer dense phase creates a distinct chemical environment that facilitates the formation of dense silica particles, the microscopic size of the dense phase droplets precluded the ability to elucidate the chemistry that leads to the regulated silicification process.

A synthetic system of macroscopic phase separation was used to show the mechanism of silica formation within dense polymer phases. By following the kinetics of silica diffusion between the dense and dilute phases, quantitative description of the condensate-mediated silicification was given. It was also shown that the dense phase can concentrate mobile silica species, which then polymerizes at appropriate conditions. This opens the option to replace the current harsh chemical conditions for producing silica-based materials with bioinspired routes.

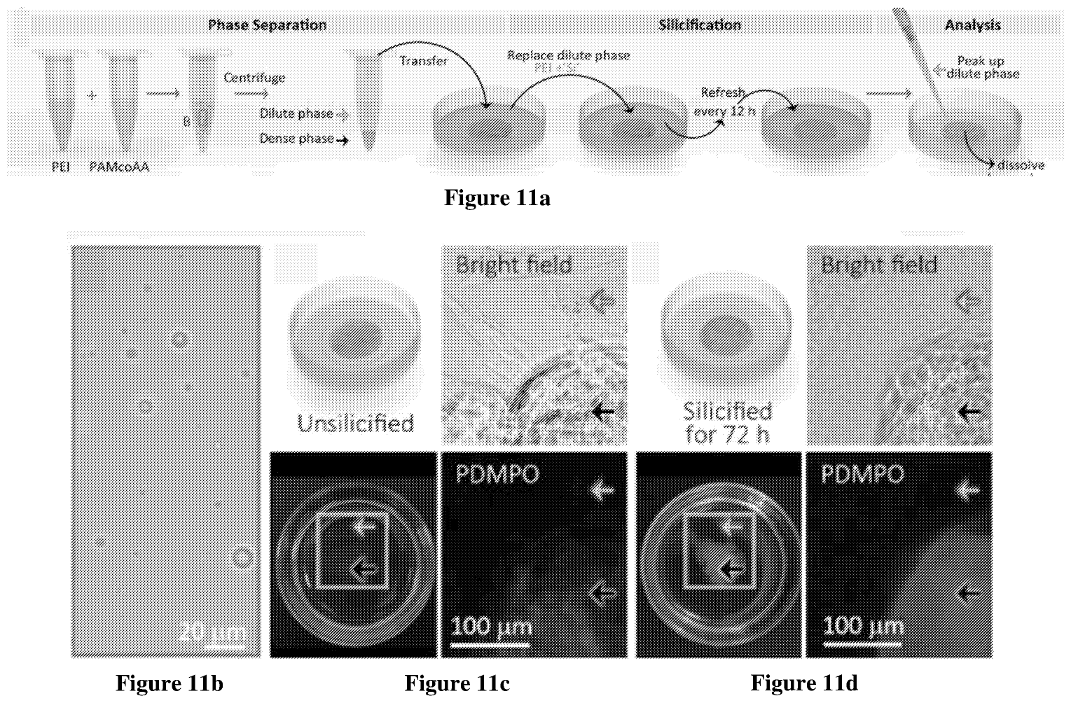

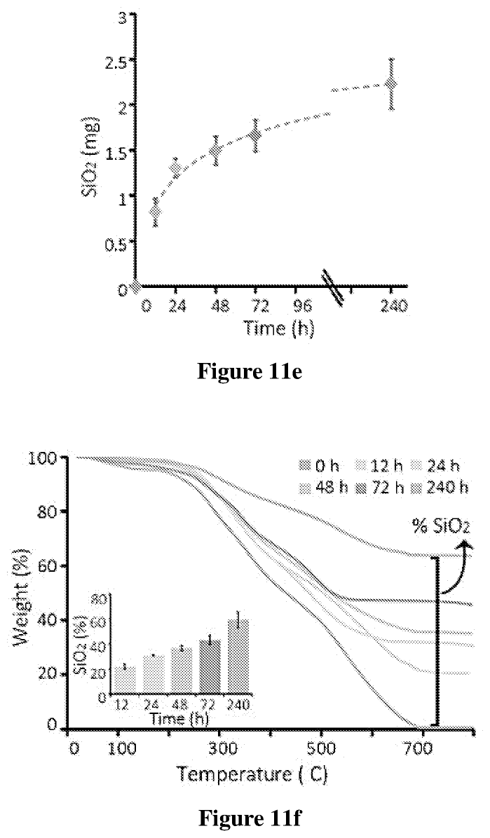

A major limitation for silicification studies of many established liquid-liquid phase separation systems is that the micrometer-scale droplets of the dense phase are dispersed in the surrounding dilute phase. This precludes the use of bulk analyses for the study of dynamic interactions between the dense and dilute phases. Various combinations of positively, amine-containing, and negatively charged polymers were explored that yielded macroscopic phase separation. Such system was achieved by mixing 50 mM of polyethylenimine (PEI) and poly(acrylamide-co-acrylic acid) (PAMcoAA). Immediately after mixing the positively charged PEI and the negatively charged PAMcoAA, the solution became turbid due to the formation of dense coacervate droplets. Letting the droplets settle or using mild centrifugation led to the coalescence and fusion of the droplets into a single dense phase (FIGS. 11a, 11b).

In order to study silicification in this system, the two phases were transferred to a Petri dish where the dense phase could spread on the hydrophilic surface, thus maximizing its surface area and reducing the time needed for diffusion between the phases. Once in the Petri dish, the original, thermodynamically equilibrated, dilute phase was replaced with a Si-containing dilute solution (FIG. 11a). The new dilute phase was a sodium silicate solution of various concentrations stabilized by 10 mM PEI. In these solutions, the PEI can stabilize most of the supersaturated silicate species from gelation for a few days by the formation of various oligomers, while the concentration of monomeric silicic acid is very close to the saturation value. Because the dilute phase in many of the experiments contained most of its silica content as various oligomeric structures, it is referred to them collectively as ‘Si’. In the experimental setup, the new dilute phase was refreshed every 12 hours to avoid macroscopic gelation and facilitate experiments spanning several days. A qualitative examination of this system shows that in the absence of Si both dilute and dense phases are transparent, but after introducing the Si-containing dilute phase, the dense phase changes its appearance to opaque and accumulates the fluorescent dye PDMPO that has high affinity to forming silica (FIG. 11c, 11d). Therefore, the system enables to follow a coacervate induced silicification process with the ability to differentiate between the dense and dilute phases.

The kinetics of coacervate silicification was monitored by conducting such experiments for time periods ranging from 12 hours to 10 days. At the end of the experiment, the dilute phase was removed and the dense phase was fully dissolved in a strong base (FIG. 11a). The amount of ‘Si’ extracted from the dense phase was quantified with a colorimetric method. These experiments show a logarithmic increase in the ‘Si’ content of the dense phase, resembling a dynamic equilibrium (FIG. 11e). The silicification of the dense phase was quantified also by a thermogravimetric analysis (TGA) of lyophilized ‘Si’-containing dense phases, demonstrating silica content that rises from 0% to ˜60% dry weight after 10 days (FIG. 11f). These results demonstrate that mobile ‘Si’ species diffuse from the dilute phase and accumulate with time in the dense phase.

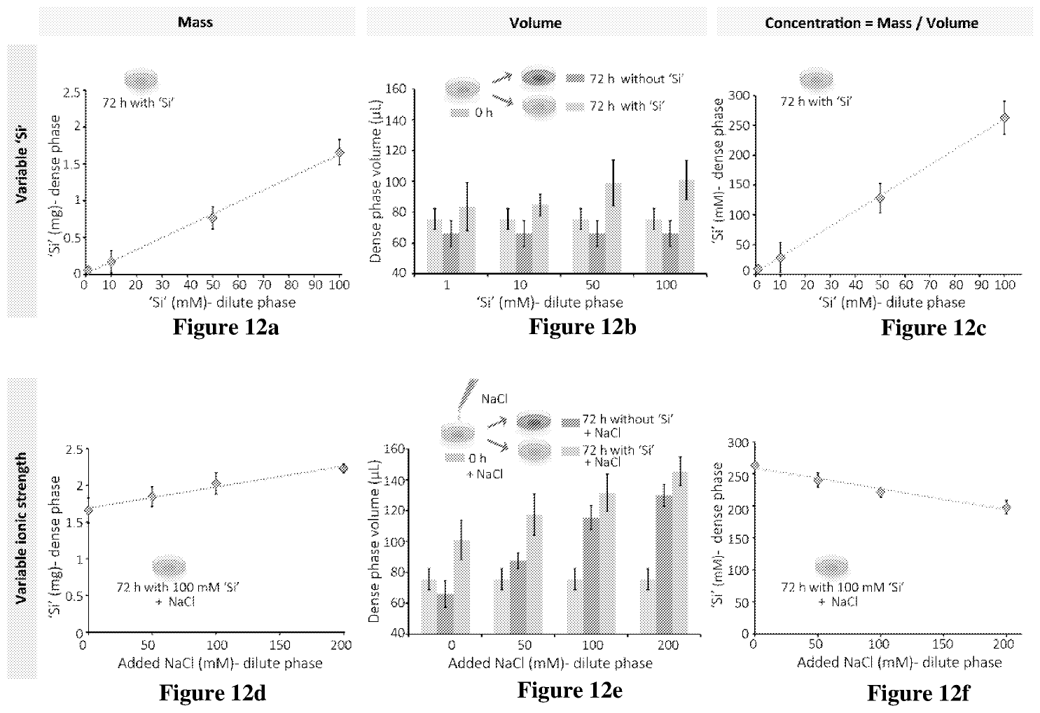

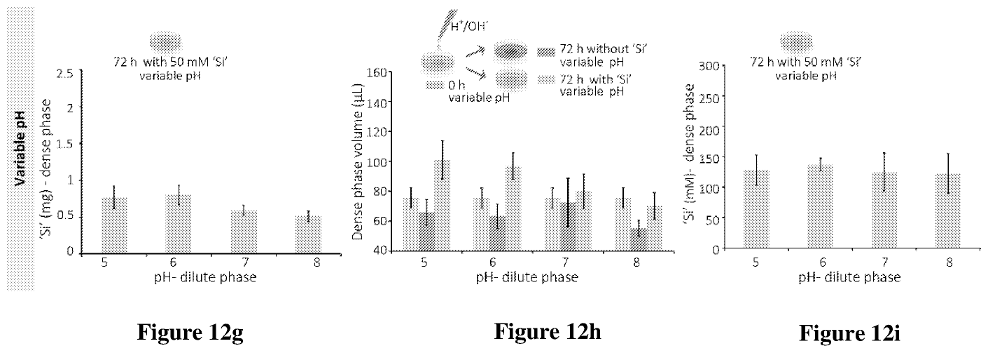

The experimental systems were used to explore how the concentration of dissolved Na₂SiO₃ in the dilute phase affects the amount of silica accumulated in the dense phase. The silica quantity in the dense phase was measured after 72-hour incubations with the ‘Si’-containing dilute phase. The results showed a linear relation between ‘Si’ concentration in the dilute phase and silica quantity in the dense phase (FIG. 12a). In order to calculate the concentration of Si in the dense phase its volume was measured at the various conditions. These measurements show a mild volume reduction of the dense phase in the absence of ‘Si’, and an increase of the volume in the presence of ‘Si’ (FIG. 12b). These volume changes were due to shifts towards new equilibrium of the polymer phase separation system, induced by changing the original composition of the dilute phase with the new Si-containing solution. The quantity of ‘Si’ in the dense phase and its volume was used to calculate ‘Si’ concentration in the dense phase after 72 hours. This shows that ‘Si’ concentrations follow a similar trend to that of ‘Si’ quantities, namely, an increase that is linearly correlated to ‘Si’ concentration in the dilute phase (FIG. 12c). Remarkably, even though the trends are similar, the nominal concentrations in the dilute and dense phases are very different, with concentrations of ‘Si’ in the dense phase higher by a factor of ˜2.5. This demonstrates an uptake process that seems to proceed against a concentration gradient without any active energy-driven process.

The influence of other factors that are known to influence silica formation, on the concentrating ability of the dense phase were measured. Elevating the ionic strength of the dilute phase by adding NaCl had a clear effect of expanding the volume of the dense phase (FIG. 12e). This is expected due to diffusion of ions into the dense phase, contributing to charge screening that loosen the intermolecular attraction and lead to a more hydrated dense phase. In addition, the quantity of silica rose with added salt, albeit when calculating ‘Si’ concentration a decrease was observed (FIG. 12d, 12f). This suggests that the expansion effect is dominant, allowing some additional ‘Si’ uptake as a byproduct, but the efficiency of ‘Si’ uptake is best without added salt. Changing the pH value of the ‘Si’-containing dilute phase also affected the system. Elevating the pH countered the expansion of the dense phase in the presence of ‘Si’, which together with a reduction in the amount of ‘Si’ leads to a constant ‘Si’ concentration in the dense phase (FIG. 12g-12i). Altogether, these observations point to a complex interaction landscape between the phase separating polymers and the silica species introduced in the dilute phase. The dense phase clearly serves as a sink for high concentrations of silica but the balance between the two phases can be manipulated by other factors such as ionic strength and pH.

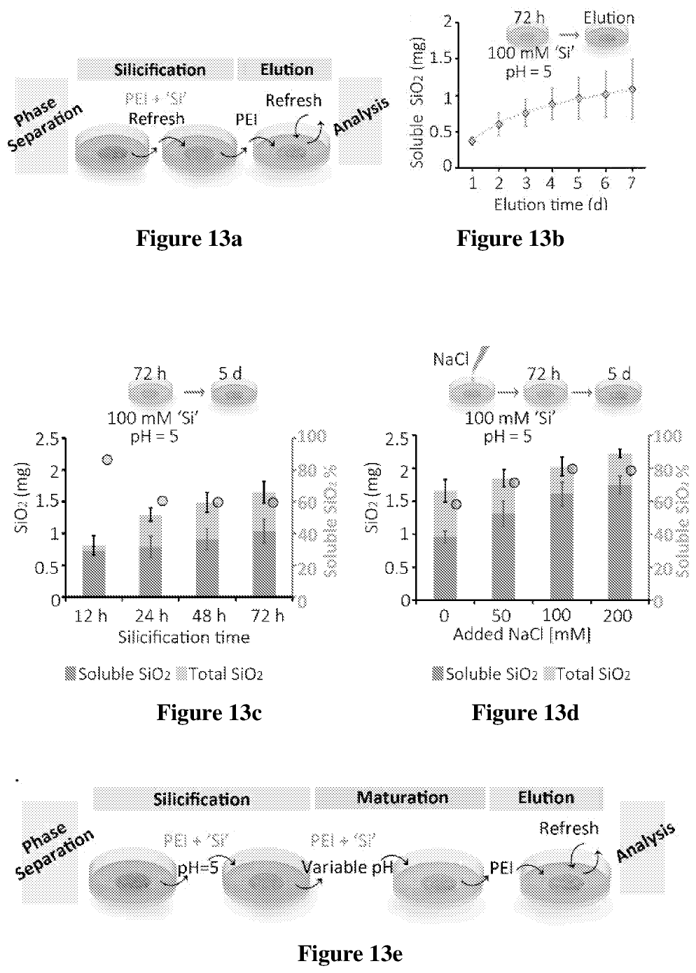

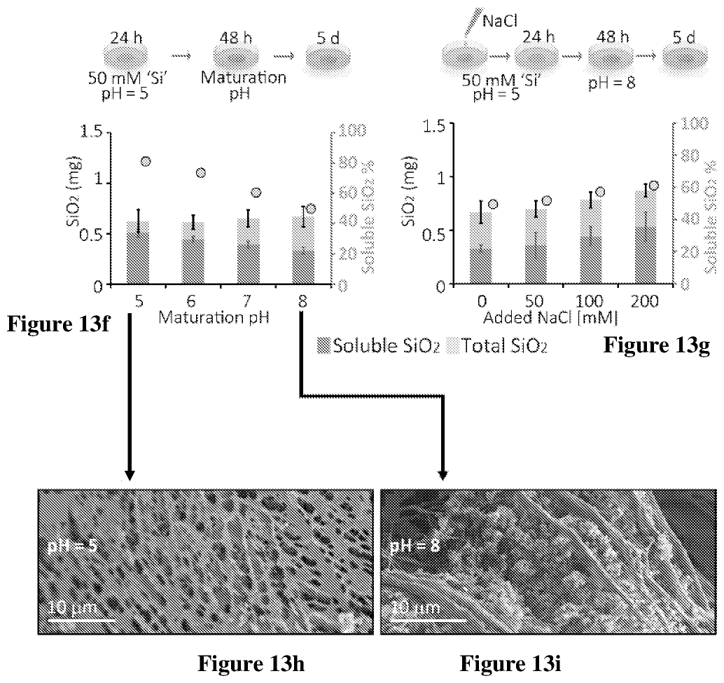

The ability of the dense phase to concentrate such high amount of ‘Si’ from the dilute phase brings the question of the chemical driving force. It is possible that inside the dense phase the silica matures into an insoluble and immobile phase that is inert to diffusion, thus allowing continuous inward diffusion of fresh mobile silica. However, the regular ratio between ‘Si’ concentrations in both phases (FIG. 12a) is reminiscent of a system with a fractionation coefficient that reaches dynamic equilibrium, where both silica pools are mobile and take part in the chemical equilibrium. This scenario was investigated by adding an elution step after the silicification step (FIG. 13a). For elution, after the designated silicification period, the ‘Si’-containing dilute phase was replaced with an identical, but ‘Si’-devoid, dilute phase. The amount of soluble silicic acid released into the dilute phase was measured each time it was refreshed. The data show time dependent increase in the cumulative amount of eluted soluble silica from the dense phase, as expected in a ‘salting-out’ system (FIG. 13b). The sum of all soluble silica eluted within 5 days as the amount of mobile silica in the dilute phase. By dissolving the dense phase in parallel experiments directly after the silicification step, the total amount of silica within it was quantified, and could be calculate the amount of insoluble silica.

The results show a gradual decrease in the fraction of soluble silica with time (FIG. 13c). Initially, after only 12 hours of silicification almost all the silica in the dense phase is at a diffusible state. As the silicification period was extended more silica was found within the dense phase and its insoluble fraction was also growing. Additional experiments using in situ Raman spectroscopy to characterize the silica phases inside the dense phase confirmed a gradual polymerization with time. This suggests that alongside the diffusion of silica into the dense phase, polymerization is occurring. However, polymerization cannot be the driving force for silica diffusion into the dense phase as the amount of mobile silica by itself increases with time, and therefore it was concluded that uptake is controlled by diffusion, while time-dependent polymerization is superimposed on this process. Another evidence supporting this conclusion is that direct measurements of insoluble silica by dissolving the dense phase after elution, constantly gave values that are smaller than the difference between total and mobile silica, making the calculated mobile fraction an underestimate. This is probably because of oligomeric species that diffuse into the dilute phase but are undetectable by the colorimetric method.

Varying chemical conditions of the phase separation system can affect the fractionation between the two phases (FIGS. 12a-12i). It was further investigated if there is also an effect on the extent of polymerization. Indeed, the ratio between mobile and insoluble silica can be controlled by ionic strength, where more added salt leads to a higher mobile silica fraction (FIG. 13d). Deconvolve diffusional fractionation between the two phases was further attempted and the precipitation of silica within the dense phase. To this end, changing pH can be useful as it affects silica polymerization, but does not influence the concentration ratio between the phases (FIG. 12i). For these experiments, the 72 hour silicification period was divided in two. For 24 hours, silica was introduced at pH=5, where it is most soluble, but for the following 48 hours the pH of the dilute phase was changed to higher pH values, triggering a concomitant change in conditions inside the dense phase (FIG. 13e). These experiments show that indeed the total amount of silica in the dense phase was constant, but the fraction of mobile silica decreased with higher pH values (FIG. 13f). In addition, imaging freeze-dried samples of the silicified dense phase shows that high pH values result in granular silica deposits between the dried polymer networks (FIG. 13h, 13i). The fine-tuned chemical interplay within the dense phase can be further demonstrated by contrasting the effect of high pH (the case of pH=8 in FIG. 13f) with the opposite effect of added salt. Such experiments, where silica maturation was done at pH=8 with varying ionic strength, show that the added salt allows more silica in the dense phase and hinders its polymerization (FIG. 13g). Altogether, silica polymerization occurs inside the dense phase to an extent and rate that is controlled by various chemical factors.

It was demonstrated that polymer phase separation has a regulatory role on silica formation as it creates a distinct environment within the dense phase. It was shows that an inherent feature of the polymer dense phase is a higher affinity for soluble silica, which can facilitate the localized polymerization process in the dense phase. This lays a mechanistic framework where the dense phase passively concentrates mobile silica from the dilute phase due to diffusional dynamic equilibrium, and these metastable silica precursors preferentially precipitate inside the dense phase.

This framework explains some of the differences between silica polymerization within the dilute and dense phases. In the dilute phase, supersaturated silica precursors undergo the known sol-gel process yielding a silica gel. On the other hand, the process of polymerization inside the dense phase occurs within a crowded environment in the presence of a higher silica concentration that is maintained via the dynamic equilibrium between the two phases. The outcome is the formation of silica granules within the organic matrix (FIG. 13h, 13i).

The challenges of studying microscopic dense phase droplets within a dilute bulk phase were eliminated by using a macroscopic phase separation system that allows to handle separately the dense and dilute phases. Nevertheless, this system suffers the limitation that diffusion gradients within the dense phase cannot be ignored. For example, when silicification was attempted inside a narrow Eppendorf tube only the first few millimeters of the dilute phase closest to the interface showed visible mineralization. This was addressed partially by spreading the dense phase, thus enlarging its surface area, but its thickness was still large enough to expose morphological differences between the dense phase periphery and interior.

These inhomogeneities within the dense phase further complicate the interplay between the two important chemical processes, diffusion of mobile silica driven by dynamic equilibrium and the polymerization of insoluble silica species. Ideally, silica polymerization should consume all mobile silica in the dense phase and support a continuous flux from the pool of mobile silica in the dilute phase until the entire dense phase will become silicified. However, the dense phase only reaches ˜60% silicification. A plausible reason is that the gradients in the dense phase caused faster silicification of its periphery, disconnecting the interior from diffusional supply, and creating an overall core-shell architecture.

A second limitation of the system, which can also contribute to the relatively low silicification efficiency, is that the phase separating polymers do not possess the optimal properties for silicification. The choice of polymers rises primarily from the experimental need for macroscopic phase separation, but it is very different from biogenic silica-associated polymers. For example, the type of amine functionality, the length of the polymers, or the charge density, are all important chemical factors that can be varied. It is plausible that the use of bioinspired polymers that resemble long-chain polyamines (LCPAs) and negatively charged proteins improve the efficiency of silica polymerization. However, this work might also highlight the limitation of a bioinspired approach, as many of the important chemical factors are unknown.

The conceptual framework of phase separation can be used as a guide to the study of bioinspired silica formation, and possibly other multi-step mineralization processes. The phase boundary facilitates an interplay between two different chemical environments that give rise to distinct, but interconnected, chemical reactions. This can give rise to concentration of the mineral building blocks within a specific phase, a situation that maintains constant supersaturation that is needed for the formation of metastable phases. The dynamic equilibrium between the dilute and dense phases allows to regulate the mineralization reactions as changes to one phase are passively propagated to the other phase and affect the formation of the mineral.

### Experimental Section

Reagents. Sodium silicate solution ((NaOH)ₓ(Na₂SiO₃)_{y}·zH₂O, 27% SiO₂, ˜6 M) from Sigma-Aldrich was used as the silicon source. Polyelectrolytes including poly(allylamine hydrochloride) (average M_{w}˜50 kDa, PAH⁺/Cl⁻=1), branched polyethyleneimine (M_{w}˜ 750 kDa), and poly(acrylic acid, sodium salt) (M_{w}˜15 kDa, PAA⁻/Na⁺=1) were purchased from Sigma-Aldrich and used without any further treatment. The reported polymer concentrations are the concentration of the functional groups, which were calculated using the reported polymer purities and average sizes. Milli-Q water (resistivity: 18.2 MΩ·cm at 25° C.) was used for solution preparation. To synthesize silica under mild conditions, all experiments were carried out at pH 5.0 (adjusted with 1 M HCl/NaOH) at room temperature.

Precipitation experiments. Precipitation experiments were conducted according to the schemes shown in FIG. 2a. A 25 μL of 200 mM PAH stock solution was dilute in milli-Q water (Sequence I), Si(Sequence II), and NaCl solutions (Sequence III), respectively. Subsequently, a 25 μL of 200 mM PAA stock solution was added for phase separation. For Sequences I and III, after phase separation, freshly prepared Si solutions (200 mM) were added to reach target concentrations for silicification. The final volumes of all reaction systems were 1 mL. Precipitation experiments for PAH+phosphate, PEI+PAA, and PEI+phosphate pairs followed Sequence III for adjusting ionic strength. To achieve low ionic strength conditions for PEI+PAA pairs, the stock solutions were dialyzed for 4 h. The concentrations of the components under each experimental reaction in FIG. 6 are shown in Table 4 and Table 5.

TABLE 4
Nominal molar concentrations (in mM) of the components for
experimental reaction described in FIG. 6 at low ionic strength level

| | | SOLUTION COMPONENTS (mM) | | | | |
|---|---|---|---|---|---|---|
| SAMPLES | | [polycation] | [polyanion] | [Si(OH)₄] | [Na⁺] | [Cl⁻] |
| PAH + P | without | 10 | 30 | 0 | 32 | 10 |
| | Si | | | | | |
| | with Si | 10 | 30 | 100 | 109.5 | 82.4 |
| PEI + PAA | without | 5 | 5 | 0 | 0.05 | 0.04 |
| | Si | | | | | |
| | with Si | 5 | 5 | 100 | 77.6 | 72.4 |
| PEI + P | without | 10 | 30 | 0 | 30.6 | 8.6 |
| | Si | | | | | |
| | with Si | 10 | 30 | 100 | 108.1 | 81 |

TABLE 5
Nominal molar concentrations (in mM) of the components for
experimental reaction described in FIG. 6 at low ionic strength level

| | | SOLUTION COMPONENTS (mM) | | | | |
|---|---|---|---|---|---|---|
| SAMPLES | | [polycation] | [polyanion] | [Si(OH)₄] | [Na⁺] | [Cl⁻] |
| PAH + P | without | 10 | 30 | 0 | 182 | 160 |
| | Si | | | | | |
| | with Si | 10 | 30 | 100 | 259.5 | 232.4 |
| PEI + PAA | without | 5 | 5 | 0 | 5 | 4.8 |
| | Si | | | | | |
| | with Si | 5 | 5 | 100 | 82.5 | 77.2 |
| PEI + P | without | 10 | 30 | 0 | 180.6 | 158.6 |
| | Si | | | | | |
| | with Si | 10 | 30 | 100 | 258.1 | 231 |

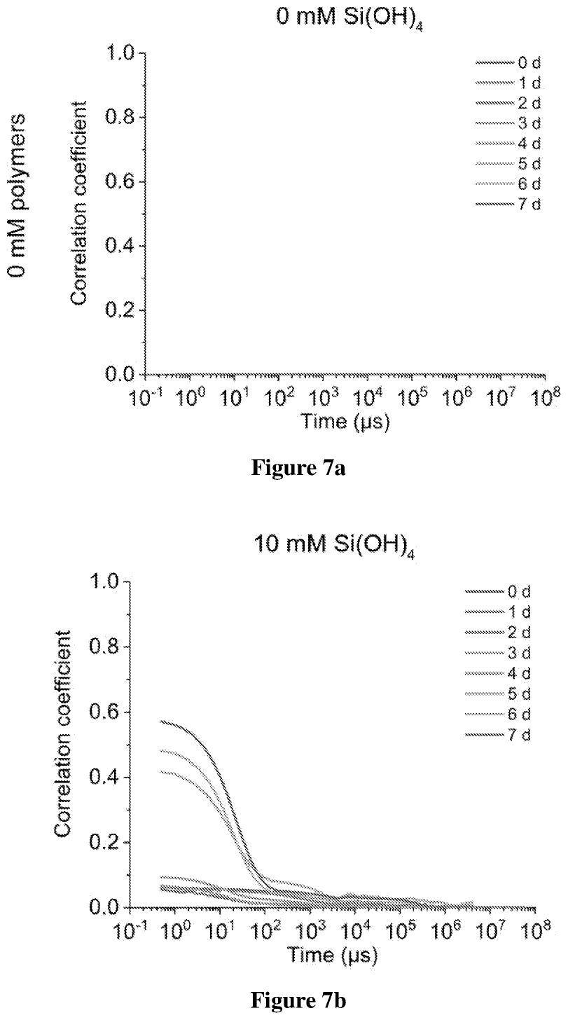

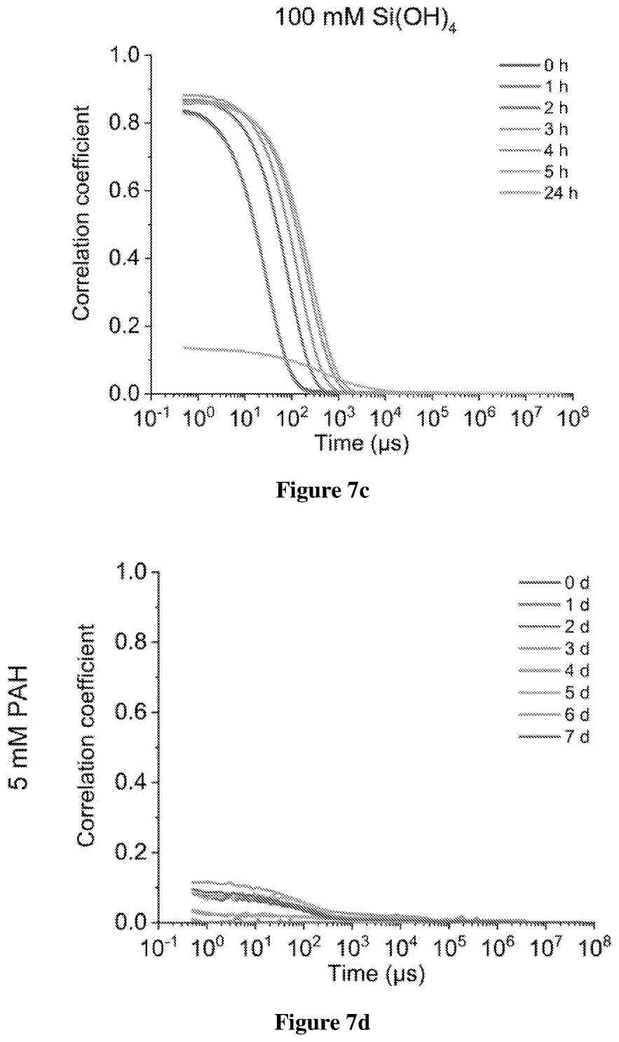

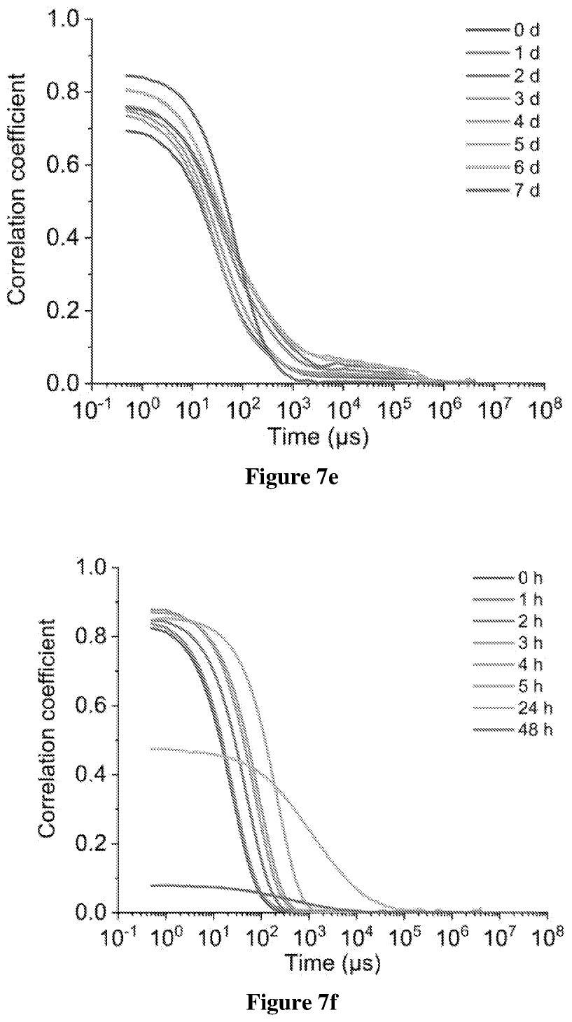

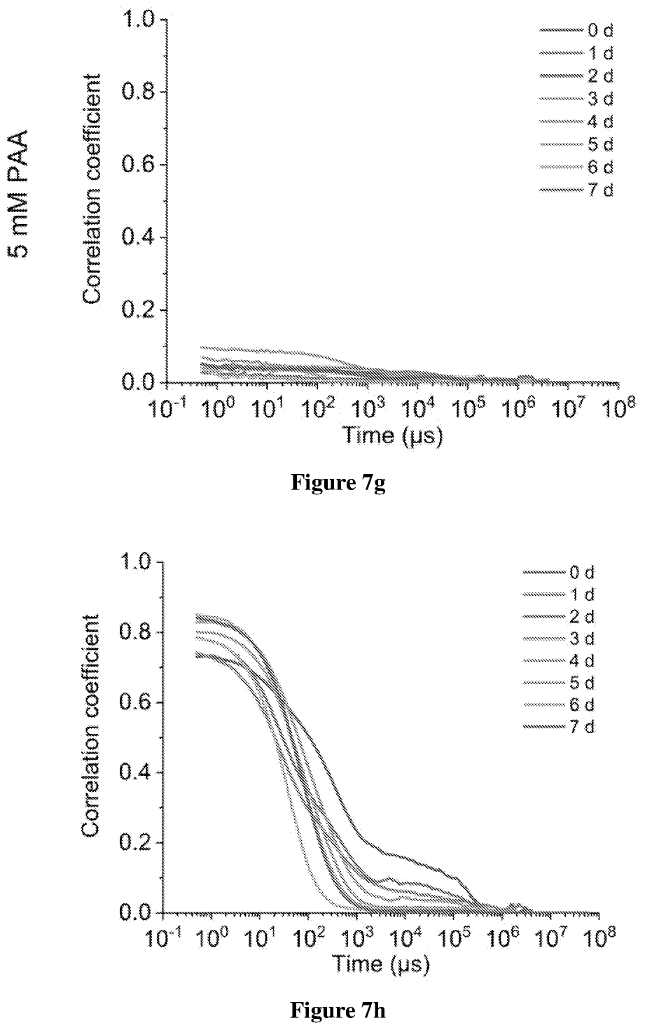

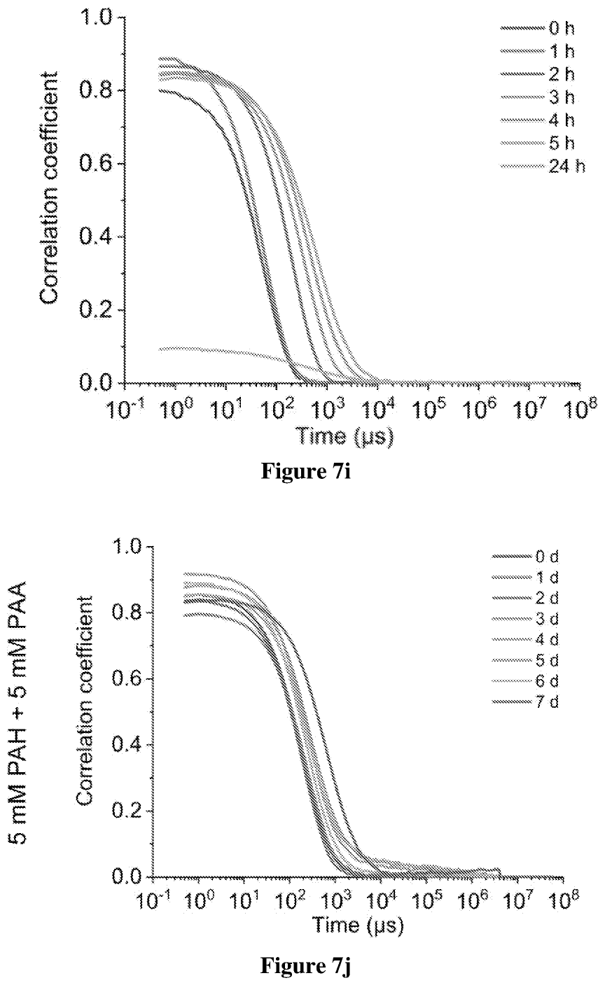

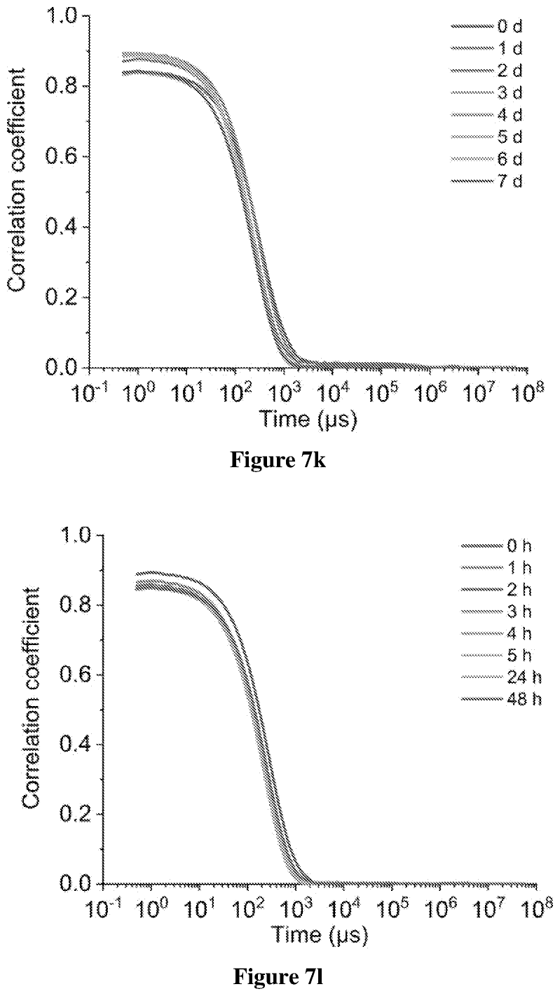

DLS. Dynamic light scattering instrument (Zetasizer Nano ZSP, Malvern Instruments, United Kingdom) equipped with a 633 nm laser was used to measure particle sizes in real-time. Raw correlograms are shown in FIGS. 7a-71. A correlation coefficient value of 0.3 was used as a threshold to report the presence of particles in the solution. The particle sizes were determined by intensity distribution and presented as the average values of three replicate measurements.

PHREEQC simulations. PHREEQC Interactive Version 3.3.7.11094 was used to model Si solutions with the wateq4f database. The simulations were performed in two steps: in the first step, the initial solution is equilibrated to calculate the Si(OH)₄ activities and the equilibrated solution was allowed to calculate the saturation indices with respect to possible Si-phases.

SEM observation of precipitate samples. Samples were centrifuged at 14000 g for 5 min. The pellets were washed with Milli-Q water three times to remove unreacted phases. Washed pellets were lyophilized and mounted onto SEM holders. The samples were coated with 5 nm iridium (Compact Coating Unit, CCU-010, Safematic), and imaged using SEM (Sigma, Zeiss).

XPS analysis. The surface components of the lyophilized silica precipitates were detected by X-ray photoelectron spectroscopy (XPS) under ultra-high vacuum conditions (5×10⁻¹⁰ Torr) using Kratos AXIS ULTRA system with a monochromatic Al Ka X-ray source (hv=1486.6 eV) at 75W with a detection pass energy of 20-80 eV. A low-energy electron flood gun (eFG) was applied for charge neutralization. To define binding energies (BE) of different elements, the C 1s peak at 284.8 eV was taken as a reference. Curve fitting analysis was based on linear or Shirley background subtraction and application of Gaussian-Lorenzian line shapes.

Quantification of precipitated Si. The amount of precipitated silica was determined using commercial silica test kit. The washed pellet was dissolved in 50 μL of 2 M NaOH by incubation at 95° C. for 1 h. The reacted solution was further diluted to 5 mL using milli-Q water and the silica concentration was subsequently determined using the silicate test kit (Merck Millipore, USA). The amount of silica was calculated by measured Si-concentration ×5 mL and present as the average values of three replicate measurements.

TGA. Lyophilized samples from several batches were collected for bulk components analyses. The precipitates were analyzed by thermal gravimetric analysis (SDT Q600, TA Instruments, USA). Analyses were performed under air atmosphere (injection rate of 100 mL/min) with a heating rate of 10 K/min. To calculate initial Si content, it was assumed that the ratio of PAH to PAA is 1:1. When Si is present as Si(OH)+, the molecular ratios of Si to PAH+PAA become ˜0.1 (low Si) and ˜1.3 (high Si) which are very close to the Si/(PAH+PAA) ratios obtained by XPS measurements.

In situ observation using cryo-TEM. 3 μL sample solution was dropped on the carbon side of plasma-discharged cleaned holey carbon R 0.6/1 Cu 200 mesh grids (Quantifoil). The back-blotted grid was vitrified using a Leica EM GP automatic plunger (Leica, Vienna, Austria) under 25° C. and 90% humidity conditions. Vitrified specimens were kept in liquid nitrogen until being used. Cryo-TEM imaging was performed on a FEI Tecnai T12 TEM microscope (Thermo Fisher Scientific, USA) equipped with an XF416 TVIP camera (TVIPS GmbH, Germany) and Gatan cryo-holders (Gatan 626-60/70, Gatan inc, USA). Images were recorded under low-dose mode with an accelerating voltage of 120 kV. For preparing dry TEM samples, a drop of 5 μL sample was deposited on a plasma-discharged carbon film grid (CF200-Cu) and then the water was blotted off with filter paper. The FEI Spirit TEM microscope equipped with a bottom-mount CCD camera (FEI Eagle 2k×2k) was used to image dry samples with the accelerating voltage of 120 kV.

Reagents. Poly(acrylamide-co-acrylic acid) (M_{w}˜520,000) and polyethylenimine (M_{w}˜750,000) were purchased from Sigma-Aldrich and used without any pretreatments. All reported polymer concentrations were used as the concentration of functional groups, which were calculated using the reported polymer purities and average sizes. Sodium silicate solution ((NaOH)ₓ(Na₂SiO₃)_{y}·zH₂O, 27% SiO₂) from Sigma-Aldrich was used as the silicon source. Ultra-pure water (Milli-Q IQ 7003 Ultrapure Lab Water System, Merck) was used for solution preparation.

Polymer phase separation and silicification. 0.25 ml PEI stock solution (200 mM, pH 5.0) was mixed with 0.25 ml PAMcoAA stock solution (200 mM, pH 5.0) and 0.5 ml milli-Q water to reach 1 ml. After 30 min the mixed solution was centrifuged at 10000 g for 3 min. Dilute phases were removed by pipette and the polymer dense phases were moved into plastic dishes for further silicification. To silicify the coacervates, 5 ml Si(OH) 4 and 10 mM PEI solution was added into the dish as a new dilute phase. The dilute phase was refreshed every 12 h.

Dynamic light scattering. Zetasizer Nano ZSP (Malvern Instruments, United Kingdom) equipped with a 633 nm laser was used for dynamic light scattering (DLS) experiments to measure particle sizes in real-time. The particle sizes were determined by intensity distribution and presented as the average values of three replicate measurements.

Light microscope imaging. Condensates were observed before and after silicification by a light microscope (Nikon Eclipse Ni—U). To track the silica within coacervates, PDMPO [2-(4-pyridyl)-5-((4-(2-dimethylaminoethyl-amino carbamoyl) methoxy)-phenyl) oxazole] (ThermoFisher Scientific, USA) was added to a final concentration of 330 UM and its fluorescence was monitored by an epifluorescence microscope.

Silica quantification. Condensates were dissolved in 5 ml 1 M NaOH. After 24 h incubation, 100 μl were further diluted to 5 ml using milli-Q water and the silica concentration was subsequently determined using the silicate test kit (Merck Millipore, USA). The amount of silica was calculated by the measured Si-concentration×5 ml and presented as the average values of three replicate measurements.

Thermogravimetric Analysis. lyophilized samples were analyzed by thermal gravimetric analysis (SDT Q600, TA Instruments, USA). Analyses were performed under air atmosphere (injection rate of 100 ml/min) with a heating rate of 10 K/min. When temperature approached 800° C., all organic parts were combusted and dry Si-contents were calculated. The dry Si-contents present in this work were present as the average values of three replicate measurements.

SEM observations. lyophilized samples were mounted onto SEM holders. The samples were coated with 5 nm iridium (Compact Coating Unit, CCU-010, Safematic), and imaged by SEM (Sigma, Zeiss) under 5 kV. Elemental analyzes were performed by Energy-dispersive x-ray spectroscopy (EDS) using an acceleration voltage of 5 kV and the signal from the sample was recorded using a Bruker Quantax microanalysis system equipped with an XFlash6 60-mm detector.

Real-time in situ Raman monitoring. Confocal Raman Microscope (labRam HR Evolution, Horiba) was performed to monitor Si-species in solutions and coacervates. To observe the samples, the ×50 objective (Olympus, IMPlanTl N) and 100 μm confocal hole were used. The spectra were obtained by using a laser at 532 nm as the excitation source with calibration by the characteristic band of silicon at 520.7 cm-1 and 600 lines/mm were set up to simultaneously scan a range of frequencies. The collected Raman data were analyzed by labSpec 6 software.

Statistical analysis. The values of direct measurements are presented as average±standard deviation collected from three independent repeats.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A system comprising at least one polyanion, at least one polycation, at least one Si source and optionally at least one ionic solution, for use in the control of morphology of precipitated silica.

2. A system of claim 1, wherein said polyanion is selected from an organic polyanion, an inorganic polyanion, an organic/inorganic polyanion and any combinations thereof.

3. A system of claim 1, wherein said polycation is selected from an organic polycation, an inorganic polycation, an organic/inorganic polycation and any combinations thereof.

4. A system of claim 1, wherein said at least one Si source is selected from at least one organic Si source, at least one inorganic Si source and any combination thereof.

5. A system of claim 1, wherein said at least one ionic solution is an aqueous ionic solution.

6. A system of claim 1, wherein said at least one ionic solution is a non-aqueous ionic solution.

7. A system of claim 1, wherein said at least one ionic solution provides said system an ionic strength capable of phase separating said at least one polyanion and at least one polycation.

8. A process for controlling the morphology of precipitated silica comprising the step of mixing (i) at least one first polyion, being at least one polycation or at least one polyanion, optionally in the presence at least one ionic solution with (ii) at least one second polyion, being the corresponding opposite polyion of said first polyion; and with at least one Si source; wherein said at least one Si source can be added either prior to mixing said first and second polyions or after mixing said first and second polyions; thereby precipitating silica with a specific morphology.

9. A process according to claim 8, wherein said at least one first polyion is at least one poly cation and at least one second polyion is at least one poly anion.

10. A process according to claim 8, wherein said at least one first polyion is at least one poly anion and at least one second polyion is at least one poly cation.

11. A process according to any claim 8, wherein said at least one first polyion is in the presence of at least one ionic solution.

12. A process according to claim 8, wherein said Si source is added prior to mixing said first and second polyions.

13. A process according to claim 8, wherein said Si source is added after mixing said first and second polyions.

14. A process according to any claim 8, wherein said polyanion is selected from an organic polyanion, an inorganic polyanion, an organic/inorganic polyanion and any combinations thereof.

15. A process according to claim 8, wherein said polycation is selected from an organic polycation, an inorganic polycation, an organic/inorganic polycation and any combinations thereof.

16. A process according to claim 8, wherein said at least one Si source is selected from at least one organic Si source, at least one inorganic Si source and any combination thereof.

17. A process according to claim 8, wherein said at least one ionic solution is an aqueous ionic solution.

18. A process according to claim 8,
